(19) United States
(12) Patent Application Publication
(10) Pub. No.: US 2016/0214664 A1
(43) Pub. Date: Jul. 28, 2016

(54) LOW-RESISTANCE SLIP DRIVE OF ENDLESS TRACK

(71) Applicant: NPC Robotics Corporation, Mound, MN (US)

(72) Inventors: Norm Domholt, Excelsior, MN (US); John David, Mound, MN (US); Michael Thoreson, Maple Grove, MN (US); Tyler Jacobson, Chaska, MN (US); Robert Allen, Gardnerville, NV (US); Michael Garrod, Minnestrista, MN (US)

(21) Appl. No.: 14/533,701

(22) Filed: Nov. 5, 2014

Related U.S. Application Data
(60) Provisional application No. 61/900,256, filed on Nov. 5, 2013.
(60) Provisional application No. 62/046,264, filed on Sep. 5, 2014.
(60) Provisional application No. 62/050,582, filed on Sep. 15, 2014.

(51) Int. Cl. B62D 55/125; B62D 55/24

(52) U.S. Cl. CPC B62D 55/125; B62D 55/244

(57) ABSTRACT

Apparatus and associated methods relate to an endless-track drive wheel having axially-projecting roller cogs circumferentially distributed, the cogs configured to engage a lugged inner surface of an endless track at a radial distance from a wheel axis greater than a wheel radius. In an illustrative embodiment, an exemplary drive wheel may have cogs axially projecting from two opposing faces of the drive wheel. In some embodiments, each cog may include a roller bearing or bushing annularly coupled to a center post. In some embodiments, the cogs on each face may be periodically distributed at a radial distance from the axis of the drive wheel. The endless track may have a series of track lugs projecting from an interior surface. In some embodiments, the track lugs may be periodically arranged along the track to have a pitch corresponding to the pitch of the drive-wheel cogs. In some embodiments, the roller bearings may advantageously provide low-resistance drive coupling to the track.

### CROSS-REFERENCE TO RELATED APPLICATIONS

This application claims the benefit of U.S. Provisional Application Ser. No. 61/900,256, titled “Modular Drone with Self-Diagnostic Performance Maximization,” filed by Norm Domholt et al., on Nov. 5, 2013, U.S. Provisional Application Ser. No. 62/046,264, titled “Low-Resistance Slip Drive of Endless Track,” filed by Michael Thoreson et al., on Sep. 5, 2014, and U.S. Provisional Application Ser. No. 62/050,582, titled “Low-Resistance Slip Drive of Endless Track,” filed by Michael Thoreson et al., on Sep. 15, 2014. The entirety of each of the foregoing applications is hereby incorporated by reference.

### TECHNICAL FIELD

Various embodiments relate generally to a drive system for an endless track.

### BACKGROUND

Track locomotion is used on many pieces of heavy equipment. Bulldozers, backhoes, and front-end loaders are examples of machines that can be configured with continuous or endless track systems of vehicle propulsion. Snowmobiles use an endless track drive system to engage a snow surface and provide locomotion to the snowmobile. Some military vehicles use an endless track propulsion system. Sometimes the term tank-tread locomotion is used, especially when referring to military tanks.

Endless track locomotion is sometimes used for off-road vehicle travel. Endless tracks can navigate terrain that is not flat or smooth. Vehicles designed for operation in such terrains may have endless track locomotion. Vehicles operating in off-road conditions may be susceptible to encountering off-road hazards, such as sharp objects or hard rocks. Endless track drive systems may not be as susceptible to locomotion failure when encountering such off-road hazards as would pneumatic tire systems.

### SUMMARY

Apparatus and associated methods relate to an endless-track drive wheel having axially-projecting roller cogs circumferentially distributed, the cogs configured to engage a lugged inner surface of an endless track at a radial distance from a wheel axis greater than a wheel radius. In an illustrative embodiment, an exemplary drive wheel may have cogs axially projecting from two opposing faces of the drive wheel. In some embodiments, each cog may include a roller bearing or bushing annularly coupled to a center post. In some embodiments, the cogs on each face may be periodically distributed at a radial distance from the axis of the drive wheel. The endless track may have a series of track lugs projecting from an interior surface. In some embodiments, the track lugs may be periodically arranged along the track to have a pitch corresponding to the pitch of the drive-wheel cogs. In some embodiments, the roller bearings may advantageously provide low-resistance drive coupling to the track.

Various embodiments may achieve one or more advantages. For example, some embodiments, low-resistance slip driven tracks may be tolerant of variations in track length. For example, tracks may expand or contract in response to environmental conditions. A track may contract in size due to cold weather, for example. A track drive system that permits slip may provide low-friction operation over a wide domain of track dimensions. In some examples, track life may be prolonged because of low-friction operation. In some embodiments, tracks may continue to be operable even if damaged and/or worn. For example, a track that has received shrapnel may remain operable even though the track may have a local abnormal dimension. In some embodiments, the track drive system may be more tolerant of dirty environments. For example, in a sandy and/or muddy environment sand and/or mud may get between the drive wheel and the endless track. The sand and/or dirt may effectively change the dimension of the endless track and/or the drive wheel. Roller cogs may permit accommodation of these modified dimensions.

Apparatus and associated methods may relate to a modular drone having a self-diagnostic system that monitors a heartbeat of each of a set of connected modules and identifies, in response to an abnormal heartbeat, a failing module. In various embodiments, the diagnostic system may, for example, determine the remaining functional capability of the drone absent the failing module, graphically display a needed replacement procedure, or report a remaining functional capability absent the failing module. In various embodiments, a user may toollessly replace the failing module and then re-employ the drone. In some embodiments, the drone may perform a diagnostic routine associated with the module whose heart beat is abnormal. The self-diagnostic system may advantageously simplify the in-field maintenance for operators with minimal training.

Various embodiments may achieve one or more advantages. For example, some embodiments may increase the uptime of drones in the field. For example, by providing graphical replacement instructions, in-field replacement by personnel with minimum training may be successfully performed. In some examples, the percentage of working drones may be maximized by scavenging the self-diagnosed working modules from otherwise non-working drones. Various embodiments may provide a user the Graphical User Interface (GUI) depicting only the drone's capabilities. This display of only working aspects of the drone may facilitate efficient drone operation by the user. For example, the user may not waste time by attempting to operate non-functional modules. By knowing what modules are operable, a user may better decide how the drone may be best deployed. In an illustrative embodiment, if the user determines that the drone's capability is not sufficient to the task at hand, the user may issue a return to home command. In some embodiments, the user may then be freed to perform another task, as the drone autonomously returns home without the need of operator input.

In various embodiments, the drone may automatically perform a reboot sequence for a module whose heart beat is abnormal. This reboot sequence may be performed in parallel with a report to the operator of the module's failure. In some embodiments, this parallel reboot may minimize the time to return to full operational capability. In some embodiments, the cost of maintenance may be minimized due to the interchangeability of modular components. For example, if a drone has one or more failing components, the entire drone need not be sent to a repair facility, but only the failing modular component(s). In some embodiments, the pulse rate of the heart beats of the components may be slowed to improve battery lifetime. For example, if a drone is in a reconnaissance mission, perhaps only a few of the modules, such as the camera and the transmitter/receiver may need to be functional, once the drone is in its destined location. The drone may turn off the unneeded modules and even periodically put to sleep the camera module, if frames need not be taken in real time.

In an exemplary embodiment, a payload may transmit its capabilities to the drone's base power unit when first connected. The base power unit may then transmit the payload capability and GUI interface to the controller in response to a new payload. The controller may then execute the GUI for controlling the newly connected payload. By using such a payload interface, the drones may need not be upgraded as new payloads are created.

The details of various embodiments are set forth in the accompanying drawings and the description below. Other features and advantages will be apparent from The description and drawings, and from the claims.

### BRIEF DESCRIPTION OF THE DRAWINGS

FIG. 1 depicts a perspective view of an exemplary roller-shaft engagement drive wheel and an exemplary endless track configured for roller shaft engagement.

FIG. 2 depicts a perspective view of an exemplary low-resistance slip drive system for an endless track.

FIGS. 3A-3B depict plane and side elevation views of an exemplary low-resistance slip drive system for an endless track. FIG. 3A depicts a plan view of an endless track. FIG. 3B depicts the endless track assembled about an exemplary low-resistance slip-drive system.

FIGS. 4A, 4B, and 4C depict perspective, side elevation and front elevation views of an exemplary roller-shaft engagement drive wheel.

FIGS. 5A, 5B, and 5C depict perspective, side elevation and front elevation views of an exemplary roller-shaft engagement drive wheel with bushings removed.

FIGS. 6A, 6B, 6C, and 6D depict an exemplary sequence of an exemplary drive wheel rotating and the corresponding track configurations resulting from drive-wheel rotation.

FIGS. 7A-7B depict an exemplary debris removal system for an exemplary bushing used on a roller shaft.

FIG. 8 depicts a perspective view of a vehicle with exemplary low-resistance slip drive endless track systems on two sides of the vehicle.

FIGS. 9A, 9B, 9C, 9D, 9E, and 9F depict various views of an exemplary modular robot carrying an exemplary payload.

FIGS. 10A, 10B, 10C, 10D, 10E, and 10F depict various views of an exemplary modular robot with an exemplary payload removed.

FIGS. 11A, 11B, 11C, 11D, 11E, and 11F depict various views of an exemplary modular robot with an exemplary payload removed and payload connectors removed.

FIGS. 12A, 12B, 12C, 12D, 12E, 12F, 12G, and 12H depict various views of an exemplary modular subsystem assembly for a modular robot.

FIGS. 13A, 13B, 13C, and 13D depict various views of an exemplary modular subsystem assembly with an exemplary robot control system removed.

FIGS. 14A, 14B, 14C, and 14D depict various views of an exemplary modular robot with a modular subsystem assembly removed.

FIGS. 15A, 15B, 15C, and 15D depict various views of an exemplary modular subsystem assembly with exemplary motor controllers removed.

FIGS. 16A, 16B, 16C, and 16C depict various views of an exemplary modular robot with a track motor removed.

FIGS. 17A, 17B, 17C, 17D, 17E, 17F, 17G, and 17H depict various views of an exemplary push-to-connect drive motor.

FIGS. 18A, 18B, 18C, and 18D depict various views of an exemplary modular robot with subsystem assembly and battery removed.

FIGS. 19A, 19B, 19C, and 19D depict various views of an exemplary subsystem assembly with battery system removed.

FIG. 20 depicts a schematic diagram of a redundantly controlled robot control system.

FIG. 21 depicts a flow chart of an exemplary diagnostic system startup method.

FIG. 22 depicts a flow chart of an exemplary artificial intelligence method.

FIG. 23 depicts a flow chart of an exemplary diagnostic system operation method.

FIG. 24 depicts an exemplary waterproof robot emerging from a lake.

FIG. 25 depicts an exemplary rescue scenario of use for an exemplary modular drone.

FIG. 26 depicts a block diagram of an exemplary modular drone and exemplary drone controller.

FIG. 27 depicts an exemplary GUI display of an exemplary drone controller.

FIGS. 28A, 28B, 28C, and 28D depict various views of an exemplary modular power base drone with a payload interface system.

FIGS. 29A, 29B, 29C, and 29D depict various views of an exemplary modular power base drone with a side access opening.

FIGS. 30A, 30B, 30C, 30D, and 30E depict various views of an exemplary modular power base drone shown with an exemplary removable battery module.

FIGS. 31A, 31B, 31C, 31D, and 31E depict various views of an exemplary modular power base drone shown with an exemplary replaceable drive motor module.

FIGS. 32A, 32B, 32C, 32D, 32E, and 32F depict various views of an exemplary modular power base drone shown with an exemplary accessible system control module.

FIGS. 33A, 33B, 33C, 33D, 33E, and 33F depict various views of an exemplary modular power base drone shown with an exemplary replaceable transmitter/receiver module.

FIGS. 34A, 34B, 34C, 34D, 34E, and 34F depict various views of an exemplary modular power base drone shown with an exemplary replaceable motor controller module.

FIGS. 35A, 35B, 35C, 35D, 35E, and 35F depict various views of an exemplary modular power base drone shown with an exemplary attachable surveillance payload module.

FIGS. 36A, 36B, 36C, 36D, 36E, and 36F depict various views of an exemplary modular power base drone shown with an exemplary attachable surveillance payload module and exemplary attachable net gun module.

FIGS. 37A, 37B, 37C, 37D, 37E, and 37F depict various views of an exemplary modular power base drone shown with an exemplary attachable net gun module. attachable net gun module.

Like reference symbols in the various drawings indicate like elements.

### DETAILED DESCRIPTION OF ILLUSTRATIVE EMBODIMENTS

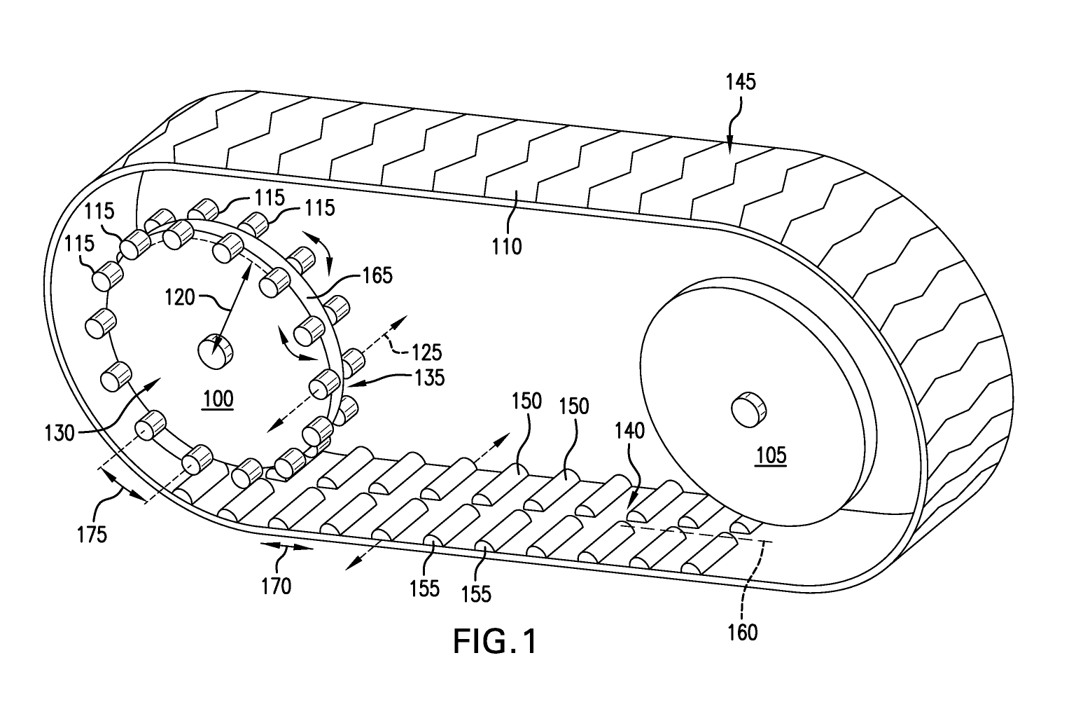

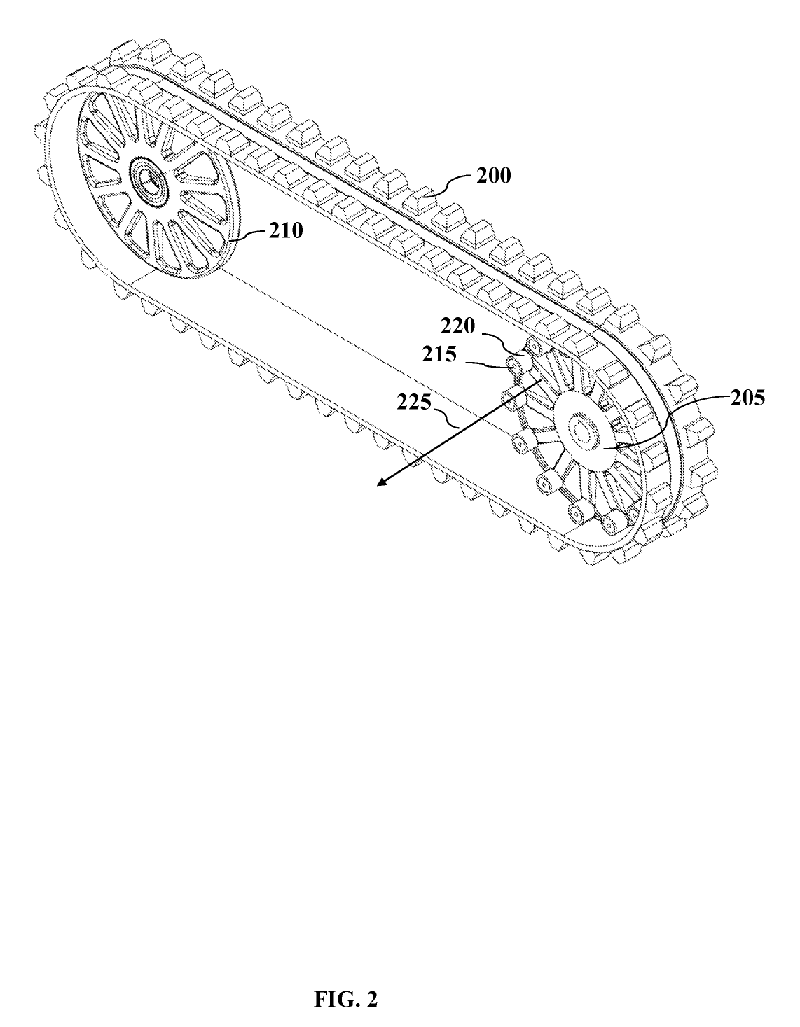

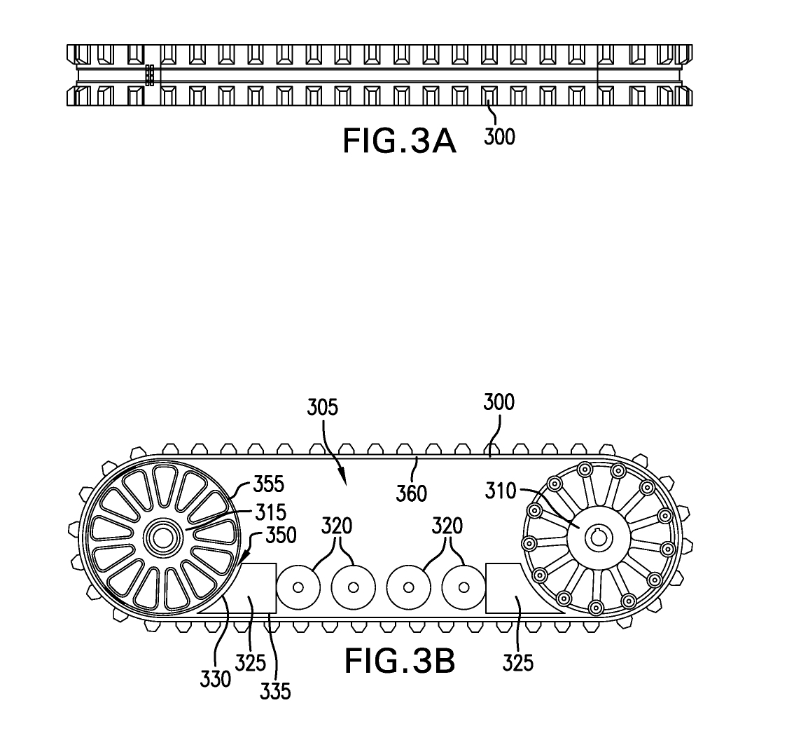

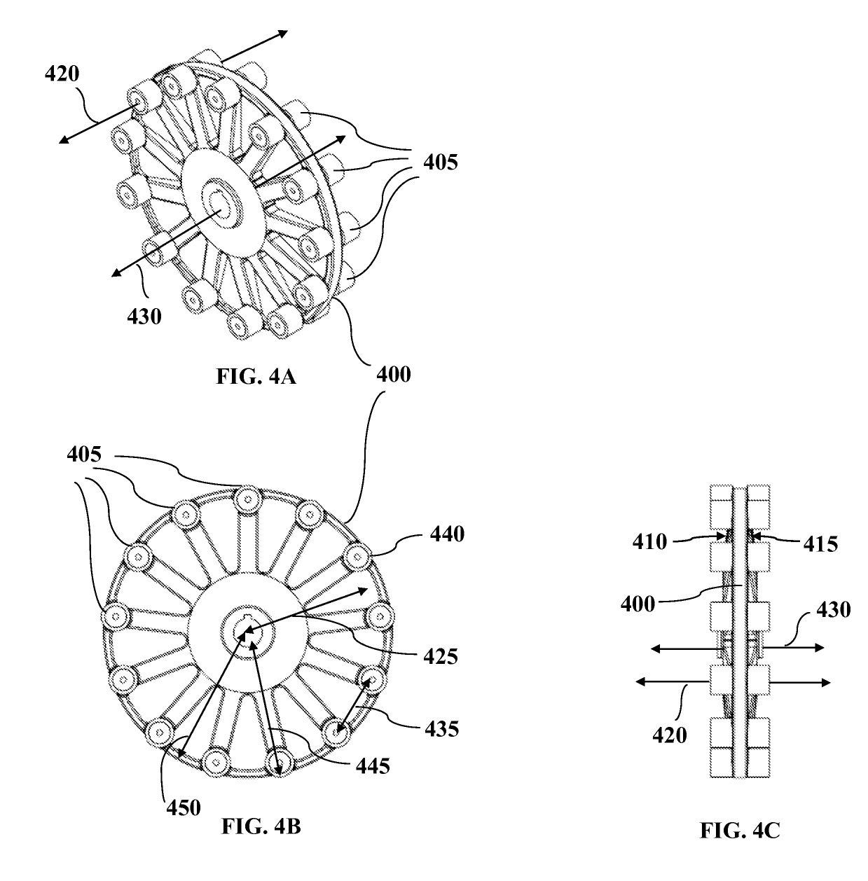

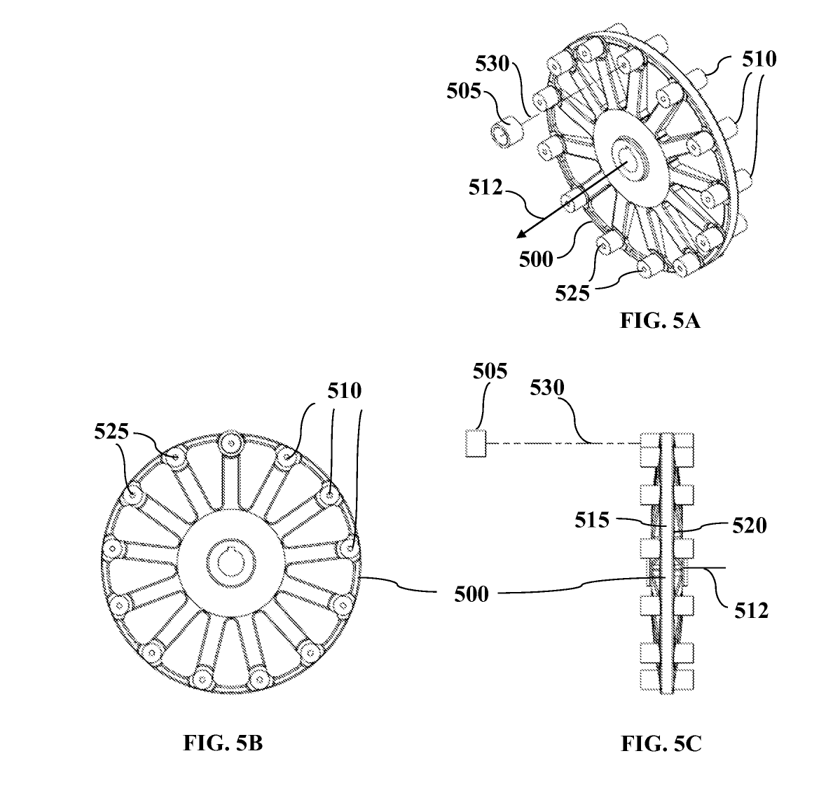

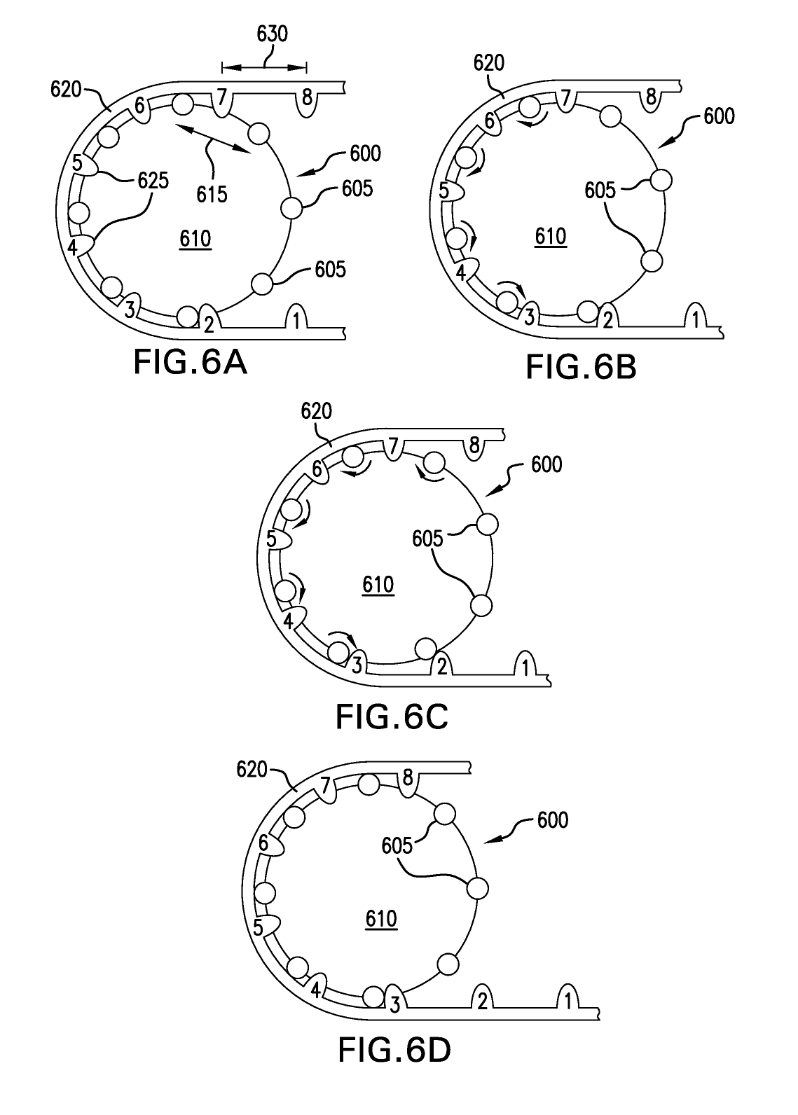

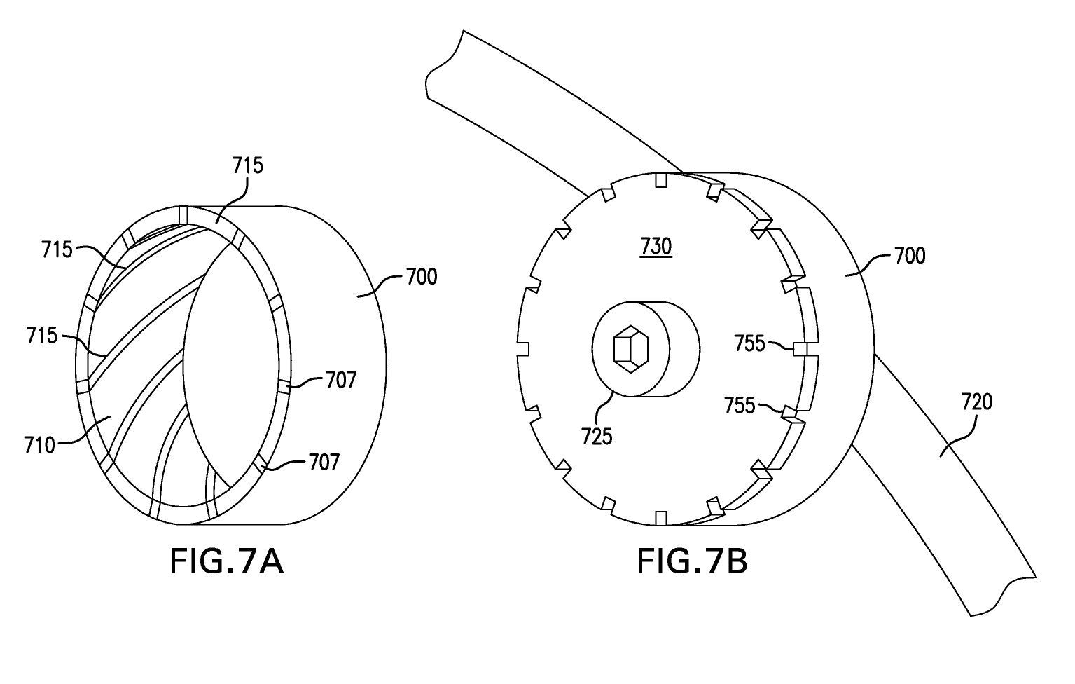

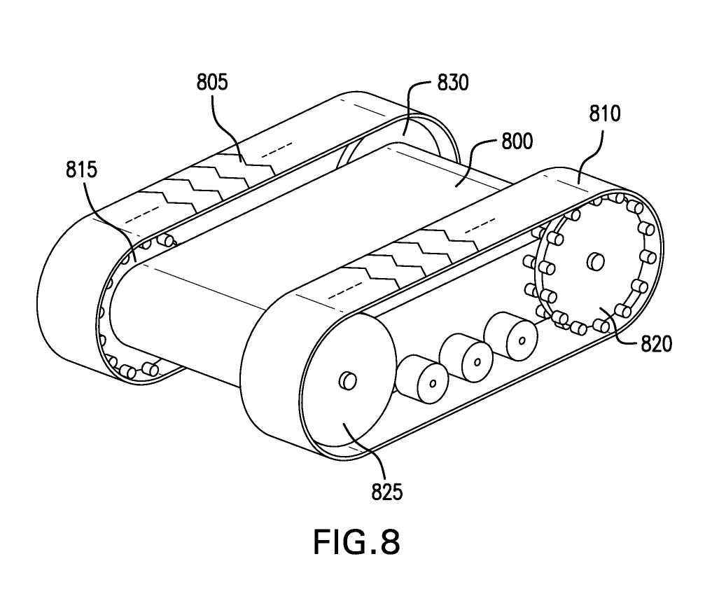

To aid understanding, this document is organized as follows. First, an exemplary low-resistance slip drive system for an endless track is briefly introduced with reference to FIGS. 1-2. Second, with reference to FIGS. 3A-3B, guide wheels and debris-blocking members will be introduced and described. Then, with reference to FIGS. 4A-4C, geometric considerations of roller bushing drive wheels will be discussed. This will be followed by a discussion of attachment methods of roller bearings to a drive wheel, with reference to FIGS. 5A-5C. A description of an exemplary drive wheel's engagement of endless track will be described, with reference to FIGS. 6A-6D. An exemplary debris removal features will be discussed, with reference to FIGS. 7A-7B. Then, with reference to FIG. 8, vehicle considerations of an exemplary roller bushing drive wheel system will be discussed.

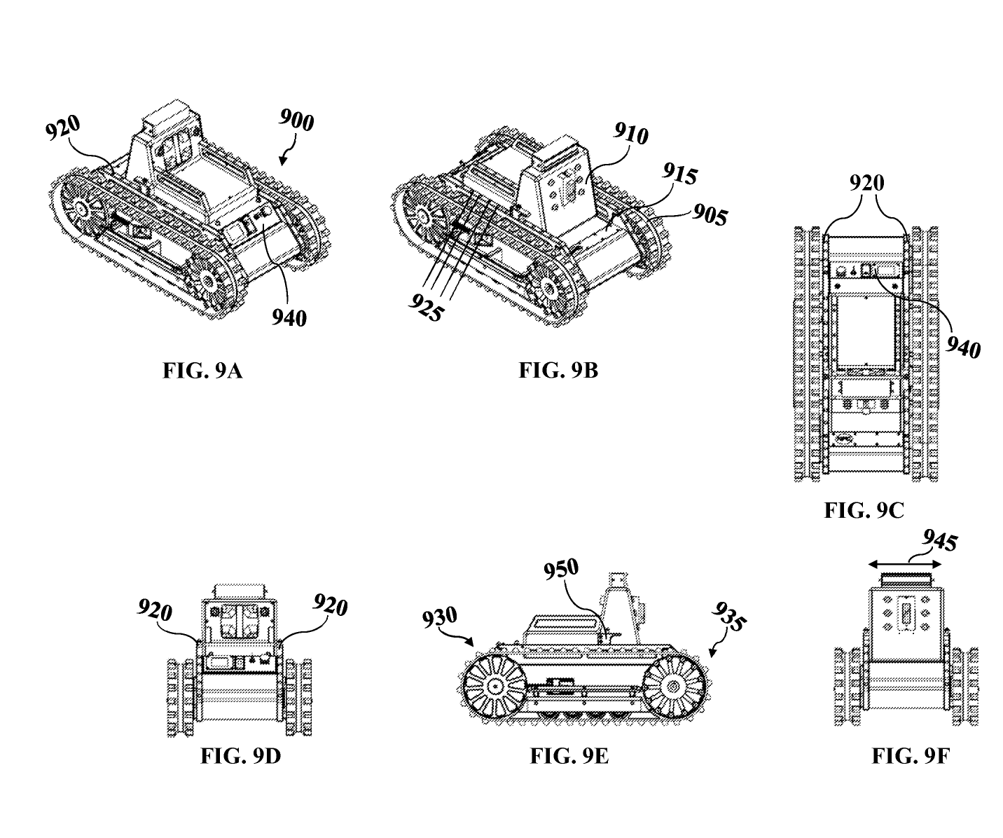

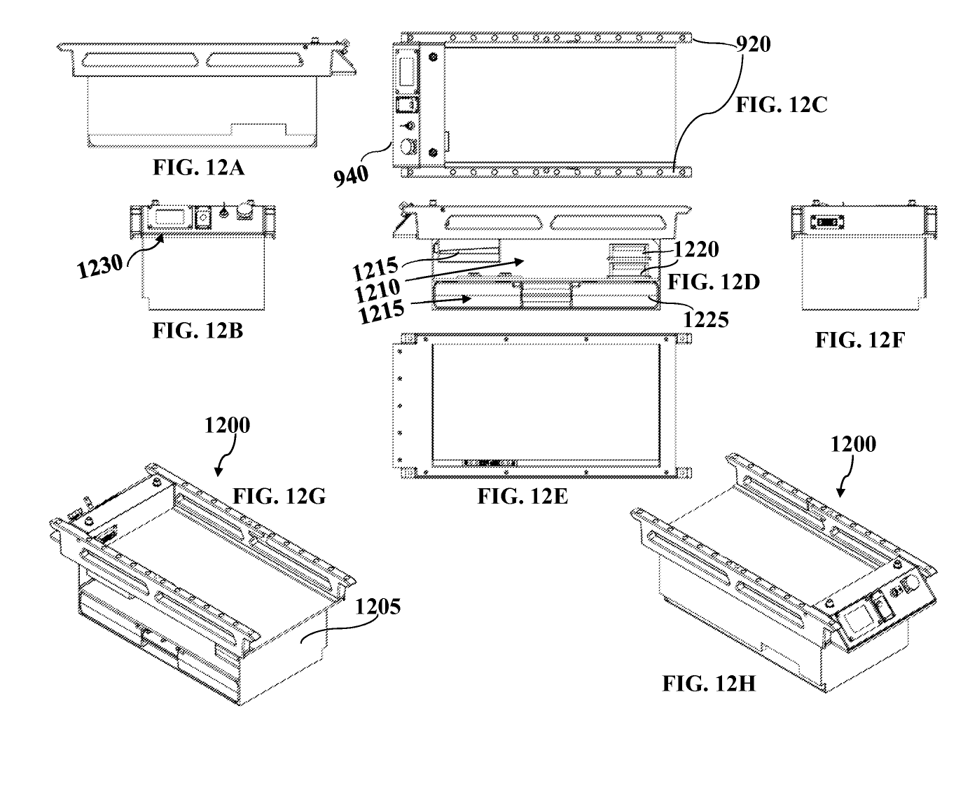

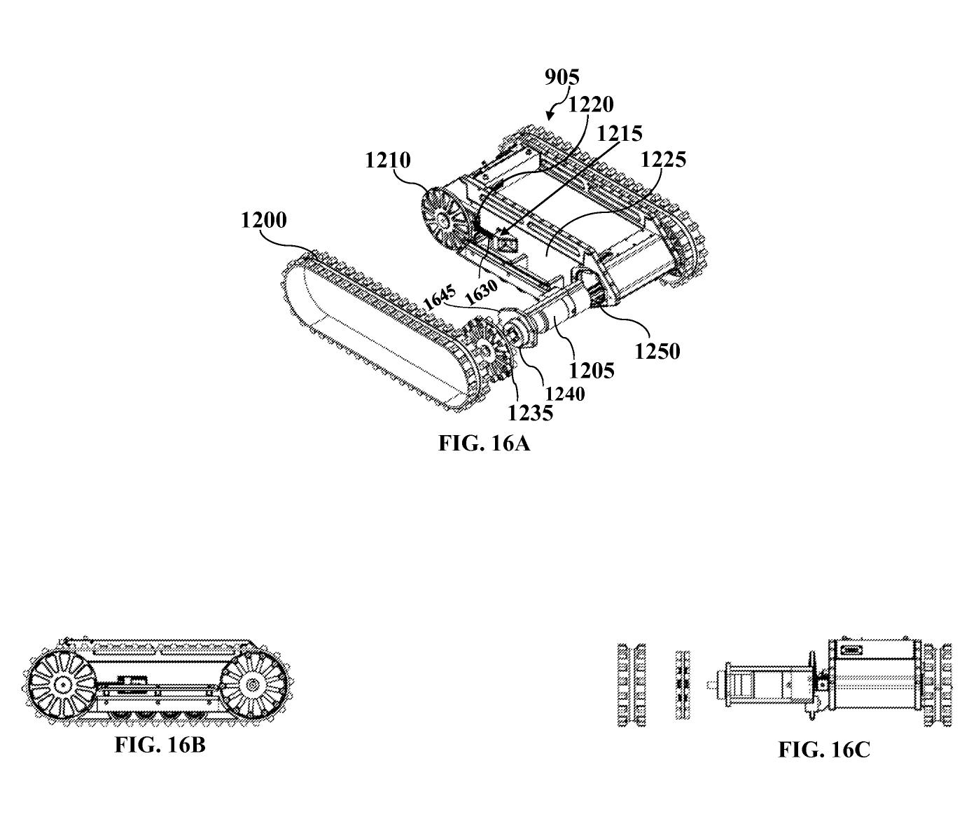

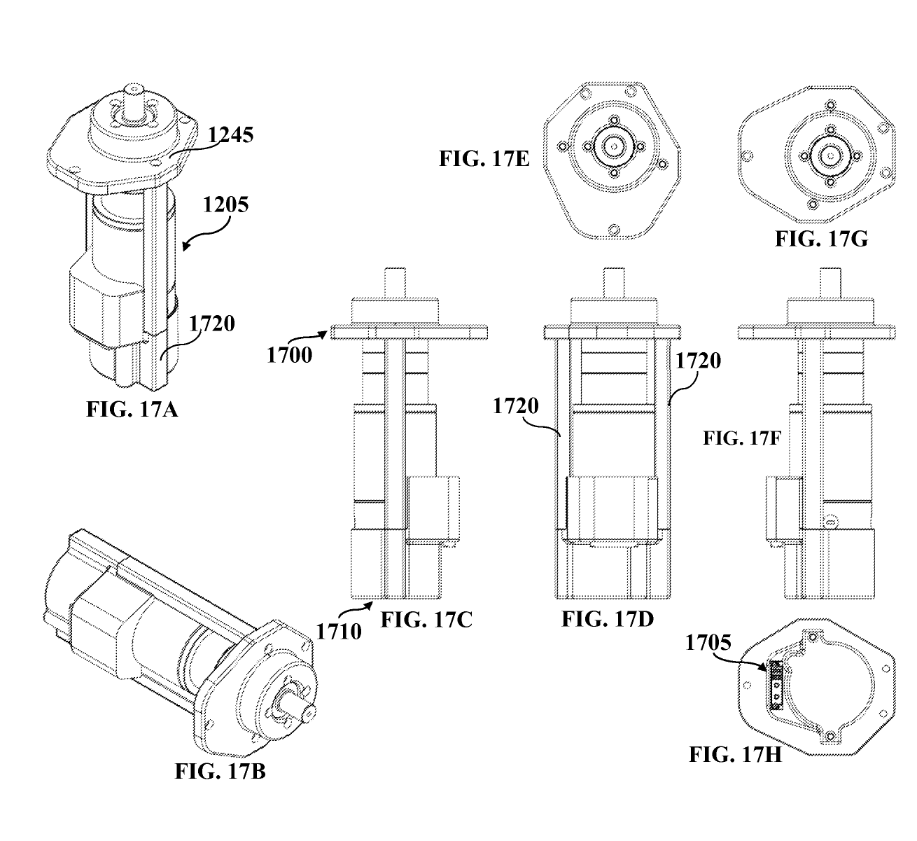

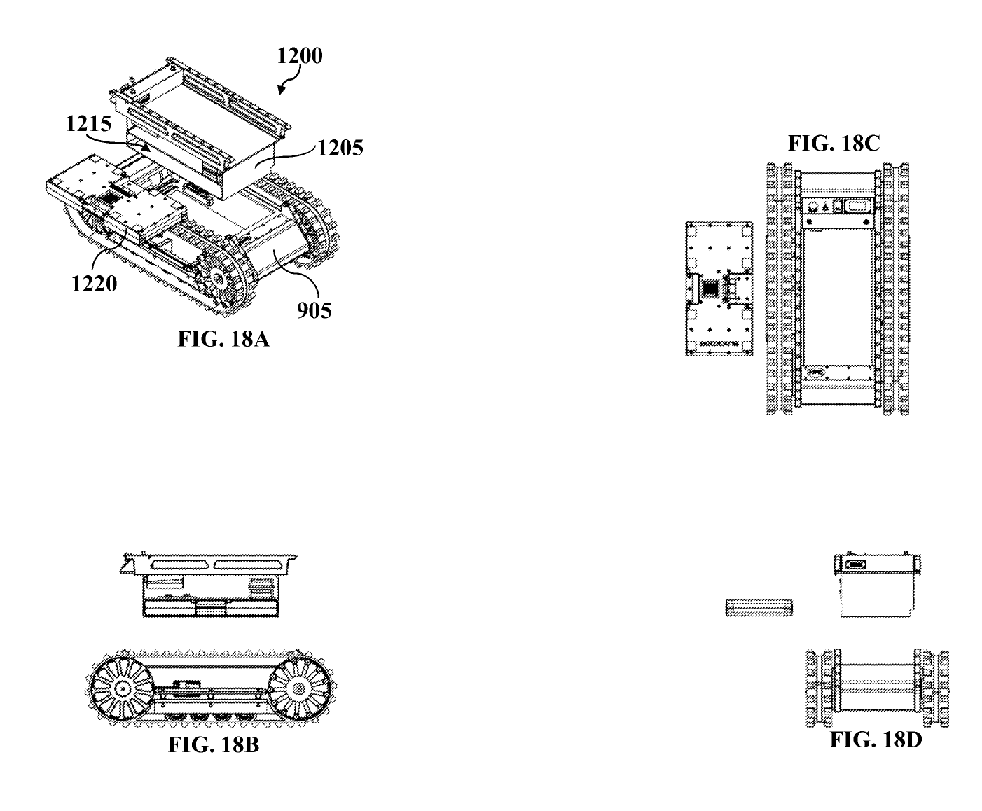

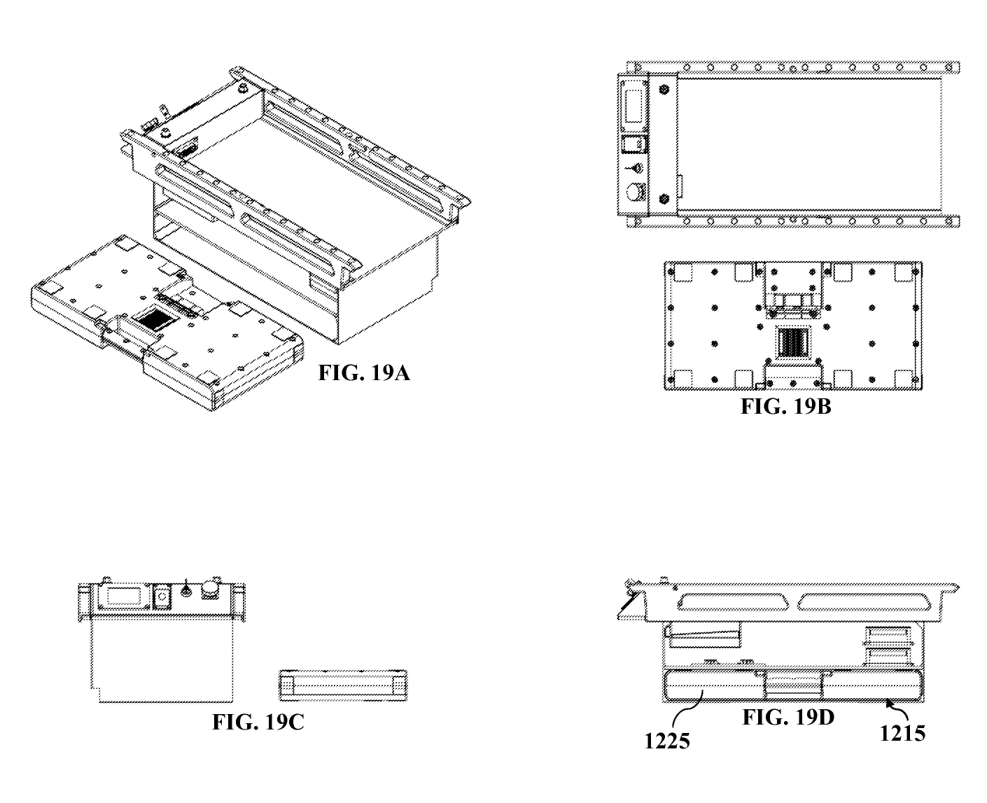

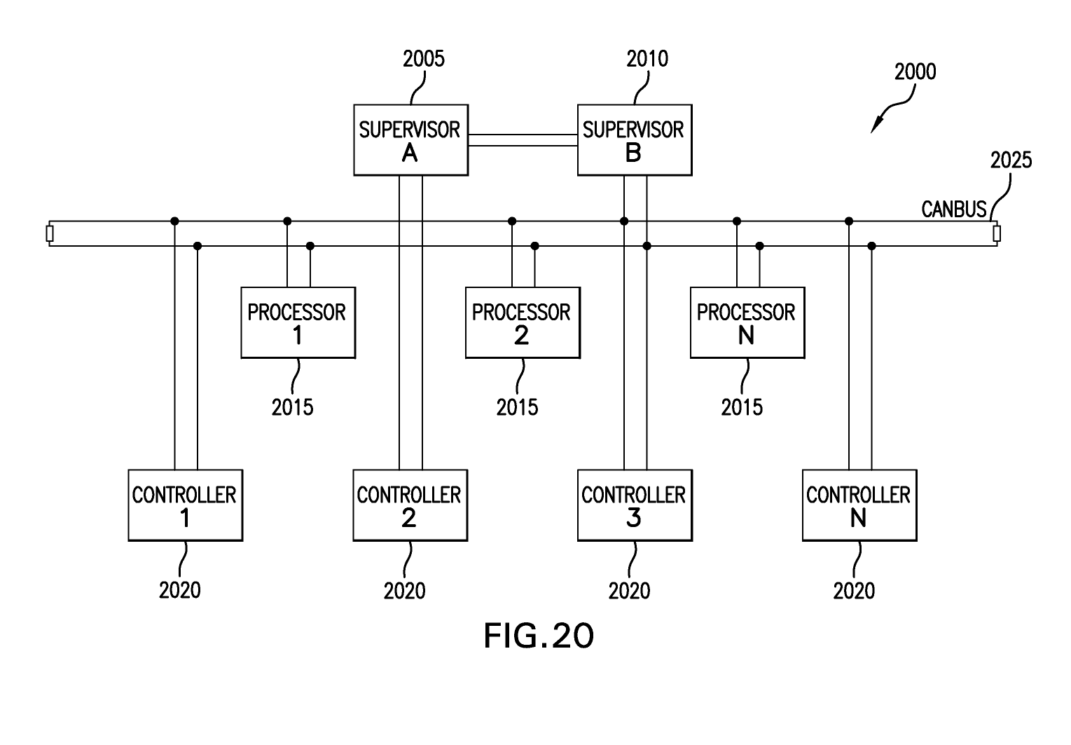

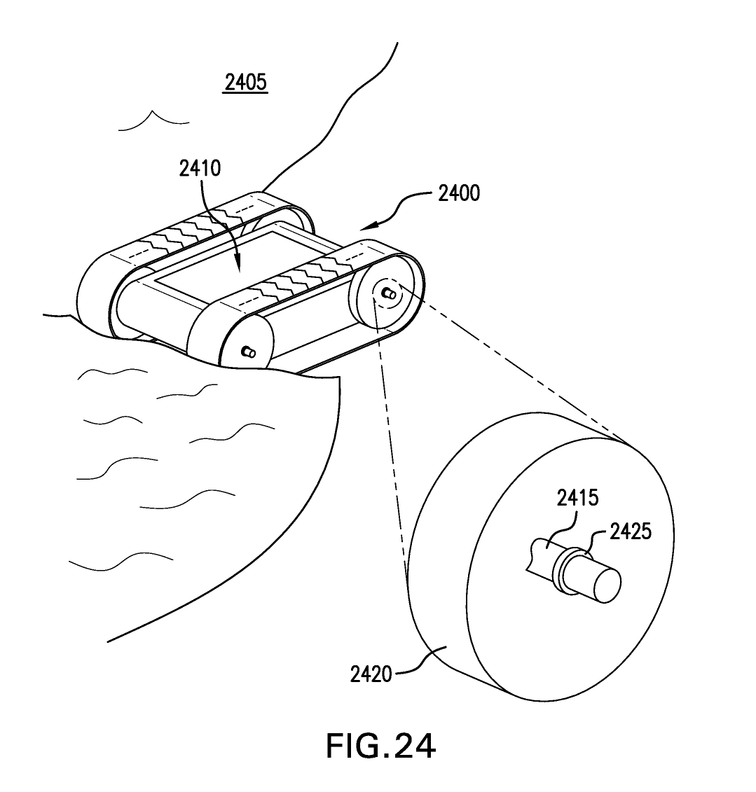

An exposition of various exemplary aspects of robot modulatiry will then follow, with reference to FIGS. 9A-19D. With reference to FIGS. 9A-11F various views of a power base and a payload will be discussed. Then various modular aspects of an electronics bay will be described, with reference to FIGS. 12A-15D. This will be followed by a discussion of modular drive motors, with reference to FIGS. 16A-17H. Modular battery considerations will be describe, with reference to FIGS. 18A-19D. Then various software aspects of an exemplary modular robot will be detailed, with reference to FIGS. 20-23. Then waterproofing considerations will be described, with reference to FIG. 24.

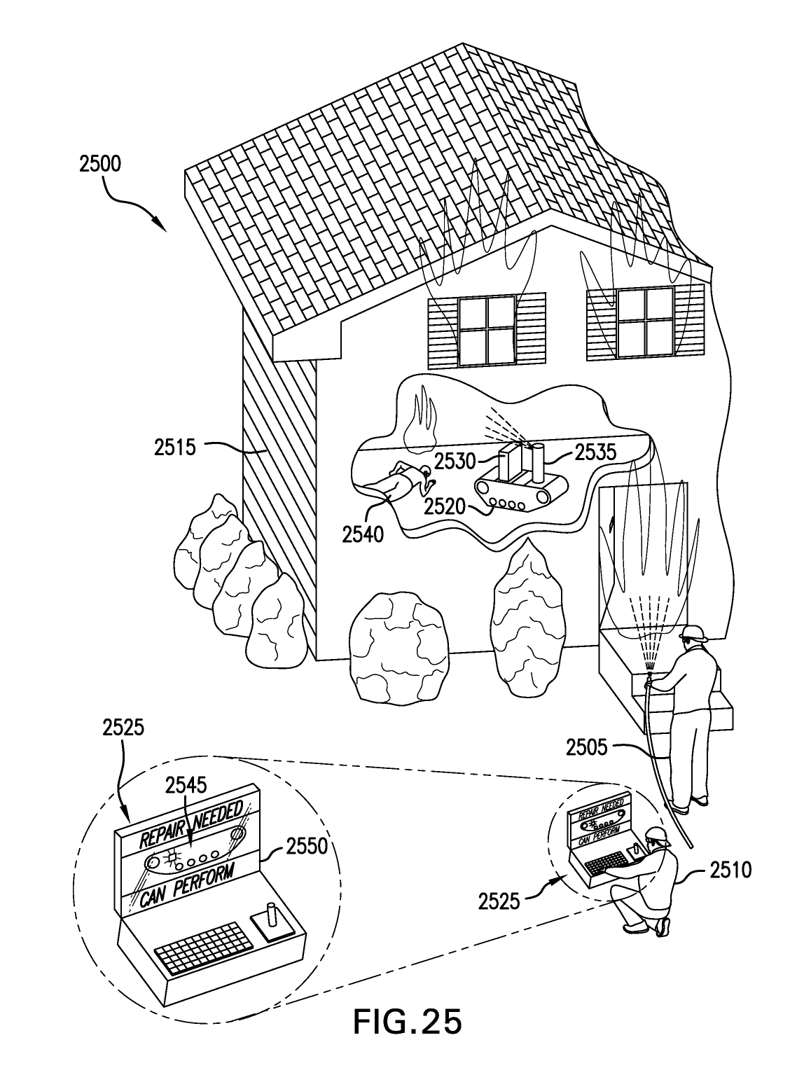

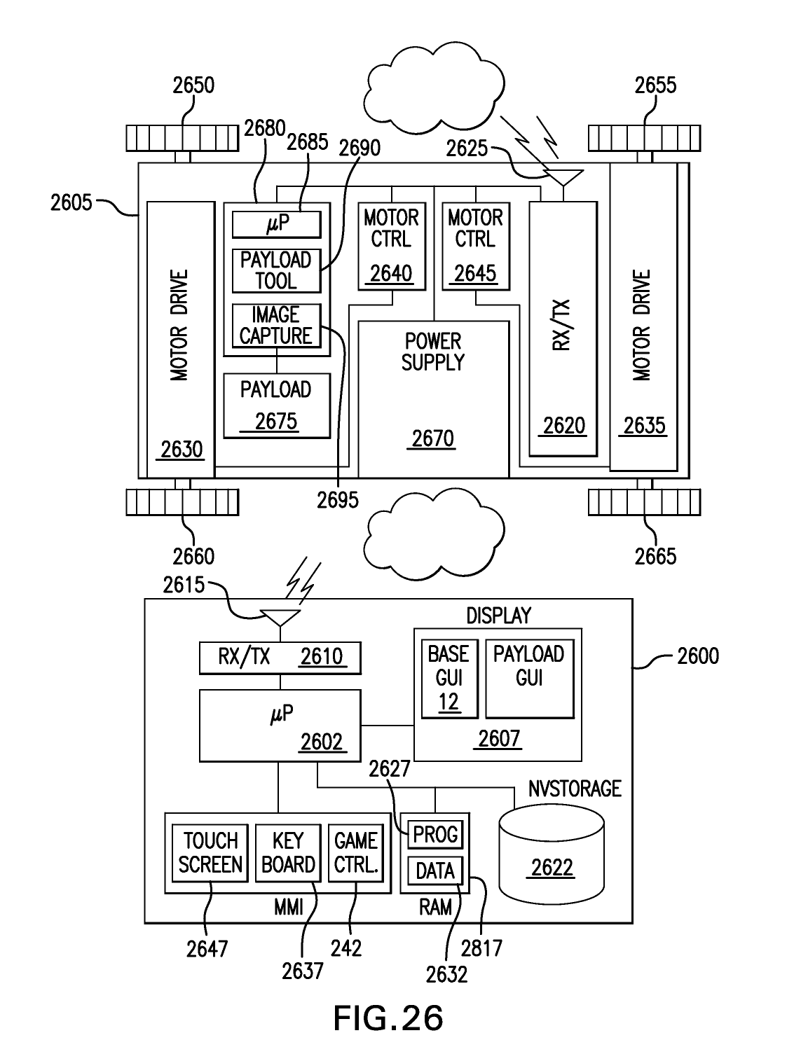

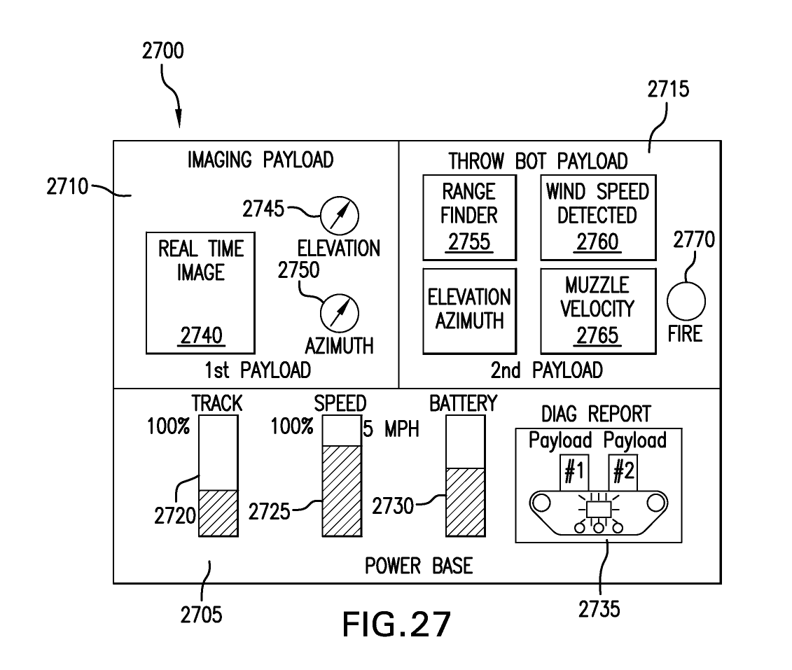

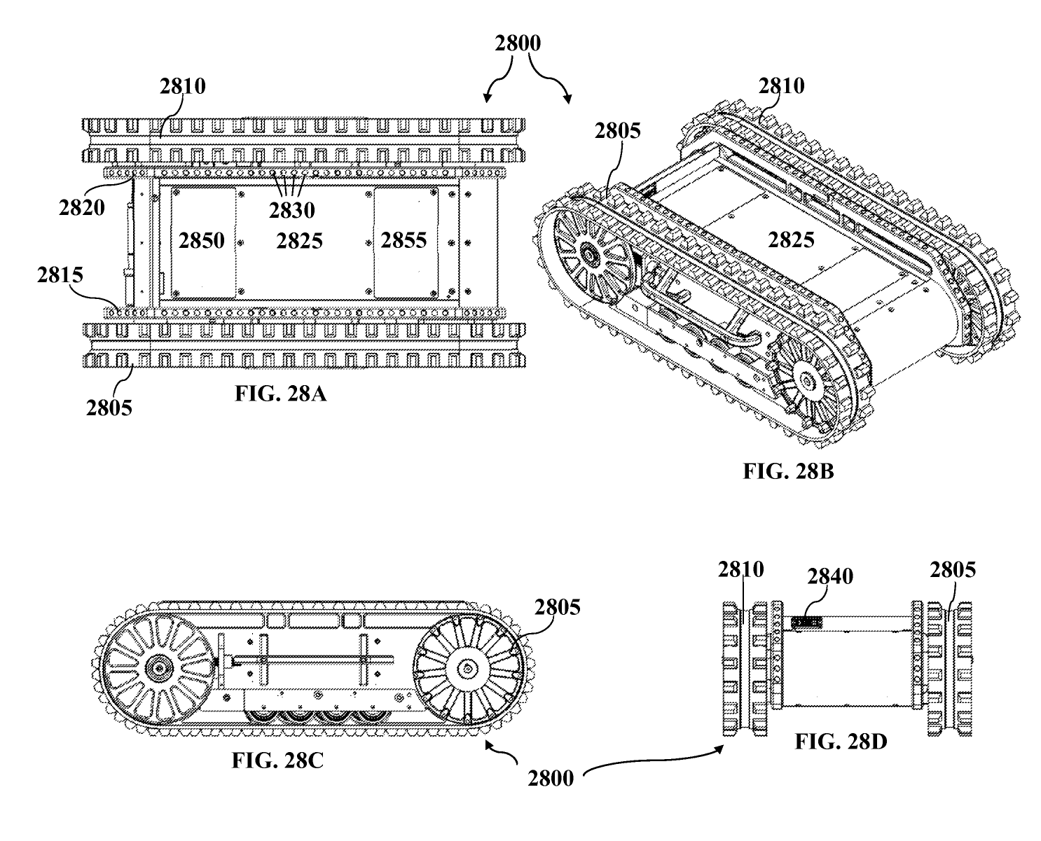

To aid understanding, this document is organized as follows. First, with reference to FIG. 25, an exemplary use of a self-diagnostic drone is used to briefly introduce some of the advantages of a modular self-diagnostic drone. Second, with reference to FIG. 26, an exemplary block diagram of both a self-diagnostic drone and a remote drone controller is described. Then, with reference to FIG. 27, the discussion turns to an exemplary embodiments of a drone controller GUI. The exemplary GUI interface will be used to show some of the ease of use, and ease of maintenance results of a toollessly repairable drone system. Finally, with reference to FIGS. 28A-37F, an exemplary modular self-diagnostic drone will be described in some detail. The descriptions of the exemplary embodiment may facilitate comprehension of some of the many possible configurations possible with the modularity of the self-diagnostic drone.

FIG. 1 depicts a perspective view of an exemplary roller-shaft engagement drive wheel and an exemplary endless track configured for roller shaft engagement. In the FIG. 1 embodiment, a drive wheel 100 and an idler wheel 105 are depicted within a circumscribing endless track 110. The drive wheel 100 includes a series of roller shafts 115 distributed at regular intervals around an outer radius 120 of the drive wheel 100. Each roller shaft 115 is rotatable about an axis 125 of the roller shaft 115. In the depicted embodiment, roller shafts 115 are located on both of two sides 130, 135 of the drive wheel 100. Each roller shaft 115 of the first side 130 of the drive wheel is axially aligned with a roller shaft 115 of the second side 135. The endless track 110 has an inside surface 140 and an outside surface 145. A series of track lugs 150, 155 project from the inside surface 140 of the endless track 110. The track lugs 150, 155 are configured to be engaged by the roller shafts 115 of the drive wheel 100. In the depicted embodiment, track lugs 150 and track lugs 155 are transversely aligned to one another on opposite sides of the interior surface 140 of the endless track 110. Between the transversely aligned track lugs 150, 155, is a channel 160 for receiving a circular periphery 165 of the drive wheel 100. This channel 160 may guide the endless track 110 as it circumscribes the drive wheel 100 in an orbital movement. The channel 160 may also guide the endless track 110 as it circumscribes the idler wheel 105.

In some embodiments, a track lug pitch 170 may correspond to an arc length 175 between adjacent roller shafts 115. For example, in some embodiments, the track lug pitch 170 may be substantially equal to the arc length 175 between adjacent roller shafts 115. In an exemplary embodiment, the track lug pitch 170 may be slightly larger than the arc length 175 between adjacent roller shafts 115, for example. When the track lug pitch 170 is slightly larger than the arc length 175 between adjacent roller shafts 115, the endless track 110 may slip with regard to the drive wheel 100. For example, the

FIG. 2 depicts a perspective view of an exemplary low-resistance slip drive system for an endless track. In FIG. 2, an endless track 200 is being driven by a drive wheel 205. An idler wheel 210 helps guide the endless track 200 on a circumferential path around both the idler wheel 210 and the drive wheel 205. A motor coupled to the drive wheel 205 may provide locomotion to the endless track 200. The idler wheel 210 may freely rotate in response to the locomotion of the endless track 200. In the depicted figure, the drive wheel 205 has a plurality of track engagement lugs 215. Each track engagement lug 215 has an annular rolling surface 220 that may freely rotate about a lug axis of rotation 225. When a portion of the endless track 200 is rotating about the drive wheel 205 at the substantially the same rates of rotation, the annular surfaces 220 may not rotate about the lug axis of rotation 225. But if the portion of the endless track 200 rotates at a rate that is not equal to the rate of rotation of the drive wheel 205, then the annual surfaces 220 may rotate about the lug axis of rotation 225. The annular surfaces 220 may rotate in response to a difference in the track speed and the drive wheel speed as measured as a speed of rotation of an annular track engagement surface.

FIGS. 3A-3B depict plan and side elevation views of an exemplary low-resistance slip drive system for an endless track. In the FIG. 3A embodiment, a plan view of an endless track 300 is shown. In FIG. 3B, the endless track 300 has been assembled about an exemplary low-resistance slip-drive system 305. The exemplary slip-drive system 305 includes a drive wheel 310, an idler wheel 315 and guide wheels 320. The drive wheel 310, the idler wheel 315 and each of the guide wheels 320 may be axially connected to a vehicle, for example. The depicted slip-drive system 305 has two debris-blocking members 325, 330. The debris blocking member 325 has a wheel-facing surface 330 and a track-facing surface 335. The wheel-facing surface 335 has a radial profile that corresponds to an outside radius of the idler wheel 315. The wheel-facing surface 335 may be in close proximity to the outside radius of the idler wheel 315. A small gap 350 may separate the wheel-facing surface 335 from an outside radial surface 355 of the idler wheel. The track-facing surface 335 may be in close proximity to an inside surface 360 of the endless track 300. When the track moves, debris on top of the inside surface 360 of the track may be obstructed by the debris blocking member 325, 330. The debris blocking member 325, 330 may prevent debris from substantially separating the endless track 300 from both the drive wheel 310 and the idler wheel 315, respectively.

In some embodiments, the guide wheels 320 may provide additional vehicle support and/or may assist in guiding the track. Such guide wheels 320 may be located between the idler wheel 315 and the drive wheel 310 along a bottom portion of the endless track 300. These guide wheels 320 may ensure that the endless track 300 has a large surface area that engages a ground surface. The guide wheels 320 may help the endless track 300 maintain ground contact beneath the guide wheels 320.

In some embodiment, the debris blocking members 325, 330 may have surface features that may direct the debris laterally away from a wheel/track interface. For example, the wheel-facing surface 330 may have groves to direct any debris caught between a wheel and the wheel facing surface 330 in a lateral direction (e.g. away from the wheel/track interface. In some embodiments, the track-facing surface 335 may have features for directing debris away from the wheel/track interface. In some embodiments, a brush may be positioned to brush debris away from the wheel/track interface, for example. In some embodiments, the track may have features on the inside surface that direction debris laterally away from the wheel/track interface.

FIGS. 4A-4C depict perspective, side elevation and front elevation views of an exemplary roller-shaft engagement drive wheel. In FIGS. 4A-4C, an exemplary roller-shaft engagement drive wheel 400 includes thirteen axially directed roller bushings 405 from each of two lateral sides 410, 415. Each of the roller bushings 405 has bearing axis 420 that is located at a common radius 425 from an axis 430 of the drive wheel 400. The roller bushings 405 are distributed about a circumference of the drive wheel 400 at a regular pitch 435. In the depicted embodiment, the each roller bushing 405 on one side 410 of the drive wheel is axially aligned with a roller bushing 405 on the other side 415 of the drive wheel. In some embodiments, the roller bushings 405 on one side of the drive wheel 410 may be staggered with respect to the roller bushings 405 on the other side of the drive wheel 415, for example. In some embodiments, the pitch 435 of the roller bushings 405 may correspond to a pitch of inside surface track features.

In some embodiments, each roller bushing 405 may engage a track along a cylindrical exterior surface 440 of the roller bushings 405. A portion of the exterior cylindrical surface may contact an interior surface of the engaged track, for example. The portion of the exterior cylindrical surface that engages the track may be the portion that is most distal from the axis 430 of the drive wheel. For example a radial distance 445 from the drive wheel axis 430 to the distal portion of the exterior cylindrical surface 440 may be greater than a radial distance 450 from the drive wheel axis 430 to an exterior cylindrical surface of the drive wheel 400. In this way, the track may engage only the roller bushings 405 and not the drive wheel 400, in some embodiments.

In some embodiments, the each roller bushing 405 is configured to engage a drive feature on an inside surface of an endless track. Various embodiments may have various configurations of roller bushings. Each configuration of roller bushings, however, may correspond to a configuration of track drive features. In the FIGS. 4A-4C embodiment, the drive wheel 400 has thirteen circumferentially distributed roller bushings 405. In some embodiments, a drive wheel 400 may have fewer roller bushings 405, for example. A drive wheel may have 2, 3, 4, 5, 6, 7, 8, 9, 10, 11, 12, or thirteen roller bushings 405, for example. In some embodiments, a drive wheel 400 may have more than thirteen roller bushings 405. A drive wheel 400 may have 14, 15, 17, 20, 23, 26, 27, or any reasonable number or roller bushings, for example. In some embodiments, roller bushings 405 may be located on both sides 410, 415 of the drive wheel 400, as in the FIGS. 4A-4C depicted embodiment. In some embodiments, the roller bushings may be located on one side 410 of the drive wheel, for example.

In some embodiments, the pitch 435 of the roller bushings 405 may be approximately equal to the pitch of corresponding track engagement features. When the pitch 435 of the roller bearings 405 is approximately equal to the pitch of the corresponding track engagement features, a plurality of roller bushings 405 may simultaneously engage a corresponding plurality of track engagement features. In some embodiments, the pitch 435 of the roller bushings 405 may be less than or greater than the pitch of the corresponding track engagement features. When the pitch 435 of the roller bushings 405 is less than or greater than the pitch of the corresponding track drive features, only one roller bearing (or two if axially aligned) may engage a track engagement feature during an engagement period.

FIGS. 5A-5C depict perspective, side elevation and from elevation views of an exemplary roller-shaft engagement drive wheel with bushings removed. In FIGS. 5A-5C, an exemplary roller bearing drive wheel 500 is shown with the roller bearings 505 detached from the drive wheel 500. In the depicted embodiment, the drive wheel 500 has bearing pedestals 510 circumferentially distributed about a central axis 512 of the drive wheel 500. The bearing pedestals 510 each axially project from a side 515, 520 of the drive wheel 500. The bearing pedestals 510 may be machined into the wheel, in some embodiments. In an exemplary embodiment, a pedestal may be pressed into a hole in the drive wheel 500 providing axially aligned pedestals on both sides 515, 520 of the drive wheel, for example. In an exemplary embodiment, the pressed pedestal may have spline features that engage complementary spline features in the hole of the drive wheel 500, for example. Each of the bearing pedestals 510 may have a bearing coupling feature 525. In the depicted embodiment, the bearing coupling feature 525 may be a threaded hole centered on an axis 530 of the bearing pedestal 510. In some embodiments a cap screw may secure the bearing 505 to bearing pedestal 510, for example. In some embodiments, the bearing may be pressed onto the pedestal.

FIGS. 6A-6D depicts an exemplary sequence of an exemplary drive wheel rotating and the corresponding track configurations resulting from drive-wheel rotation. In FIGS. 6A-6C, a drive wheel 600 is moving an endless track vehicle causing the track 605 to move. In the depicted embodiment, the drive wheel 600 has eight axially directing track-engagement cogs 605. The track engagement cogs 605 are coupled to a wheel 610 circumferentially about the wheel 610. Each of the track-engagement cogs 605 has a common cog-separation distance 615 from its nearest neighboring track-engagement cogs 605. An endless track 620 is being driven by the drive wheel 600. The endless track 620 has drive-wheel engagement lugs 625 that are periodically distributed along the inside surface of the endless track 620. Each of the drive-wheel engagement lugs 625 has a common lug-separation distance 630 from its nearest neighboring drive-wheel engagement lugs 625. In the depicted embodiment, the cog-separation distance 615 is greater than the lug-separation distance 630.

FIGS. 6A-6D depict a sequence of successive figures as the drive wheel 600 is driven in a counter-clockwise direction. In FIG. 6A, only one of the track engagement cogs 605 has engaged a drive-wheel engagement lug 625; the six o'clock track-engagement cog has engaged the number 2 drive-wheel engagement lug. FIG. 6B depicts the drive-wheel 600 after it has rotated a small amount. The track-engagement cog 605, which has engaged the number two drive-wheel engagement lug has now rotated to the 5:30 position, and is beginning to elevate along the number two drive-wheel engagement lug. This elevation on the number two drive-wheel engagement cog permits the motion of the drive wheel 600 to exceed the motion of the endless track 620. The 7:00, 8:30, 10:00, and 11:30 track engagement cogs are rotating due to the difference in the motions of the track 620 and the drive-wheel 600.

FIG. 6C depicts the position of the drive wheel 600 after being rotated such that the track engagement cog 605 which has been engaged with the number two drive-wheel engagement cog is now in the 5:00 position. In this figure, both the 5:00 and the 6:30 track-engagement cogs have engaged one of the drive-wheel engagement lugs, the number two and number three cogs, respectively. The 8:00, 9:30, 11:00, and 12:30 track engagement cogs, have rotated about each their axes to advance nearer their respective drive-wheel engagement cogs. In FIG. 6D, the drive wheel 600 has rotated such that the track engagement cog 605 which engages the number three drive-wheel engagement cog is now in the 6:00 position.

In the FIGS. 6A-6D embodiment, the drive-wheel engagement lug that is engaged is engaged from the 6:30 position until it has rotated to the 5:00 position. This engagement period can be designed to be located at a different phase of the rotation or for a different rotation duration. For example, a drive wheel with more track-engagement cogs may have a smaller arc of engagement. The shape of the drive-wheel engagement lug may alter change point of rotation where the handoff of engagement from a first drive-wheel engagement lug to a subsequent drive-wheel engagement lug. When the direction or rotation is reversed, the engaged drive-wheel engagement lug 625 may change from the 6:00 lug to the 12:00 lug, in some embodiments. Similarly, if the cog-separation distance is less than the lug-separation distance, the engaged lug when the drive wheel is rotated in the counter-clockwise direction may be the 12:00 track-engagement cog instead of the 6:00 track-engagement cog.

FIGS. 7A-7B depicts an exemplary debris removal system for an exemplary bushing used on a roller shaft. In FIG. 7A, an exemplary bushing 700 for a track-engagement is depicted. The bushing 700 has debris removal features 705 on an interior surface 710 of the bushing 700. The depicted debris removal features 705 may be spiral channels 705 in the interior surface 710. Corresponding channels 707 may be located on a lateral surface 715 of the bushing 700. In FIG. 7B, the exemplary bushing 700 has been coupled to a wheel 720 via a connector 725. The connector 725 has engaged a bushing cover 730 that has debris removal features 735 which correspond to the debris removal features 705, 707 of the bushing 700. As the bushing 700 rotates, debris that resides between the interior surface 710 of the bushing 700 and a post (not depicted). When the bushing rotates, debris may preferential locate within the channels 705. The debris then may roll or slide along the channel in response to further bushing rotation. The debris may then be expelled laterally from the bushing.

FIG. 8 is a perspective view of a vehicle with exemplary low-resistance slip drive endless track systems on two sides of the vehicle. In FIG. 8, a vehicle 800 has a right track 805 and a left track 810. The right track 805 is driven by a right drive wheel 815 on the right front side of the vehicle 800. The left track 810 is driven by a left drive wheel 820 on the left rear side of the vehicle 800. A left front idler wheel 825 is circumscribed by the left track 810, and a right rear idler wheel 830 is circumscribed by the right track 805. The right drive wheel 815 and the left drive wheel 820 may independently be controlled by a motor, in some embodiments. In some embodiments, the right drive wheel and the left drive wheel may be identical to one another. In an exemplary embodiment, the right drive wheel may have track engagement cogs that have a larger cog-pitch than a lug-pitch of drive-wheel engagement lugs of the right track 805, for example. The left drive wheel may have track engagement cogs that have a smaller cog-pitch than the lug-pitch of the drive-wheel engagement lugs of the left track 810, in this exemplary embodiment. In this way, when the vehicle is locomoted in the forward direction, both left and right drive wheels may engage their respective left and right tracks using a 6:00 track-engagement cog. The weight of the vehicle may provide help ensure that the engaged cogs do not slip, when locomoting in the forward direction.

Although various embodiments have been described with reference to the Figures, other embodiments are possible. For example, in some embodiments, an endless track may circumscribe two or more roller being drive wheels. For example a roller bearing drive wheel may be both located at a front vehicle location and a rear vehicle location. In some embodiments, sealed bearings may be used to prevent debris contamination. In some embodiments, a roller bearing wheel may be used as an idler wheel to provide more lateral track engagement, for example.

FIGS. 9A-9F depict various views of an exemplary modular configurable robot carrying an exemplary payload. In FIGS. 9A-9F an exemplary modular configurable robot 900 includes a base unit 905 and a payload unit 910. The payload unit 910 has been electrically and mechanically coupled to the base unit 905. The payload unit 910 and the base unit have complementary mechanical and complementary electrical coupling interfaces. The base unit 905 has a mechanical coupling interface that includes a substantially planar surface 915. On either of two opposing lateral sides of the substantially planar surface is a connecting rail 920. The connecting rails 920 are substantially parallel to one another and define a payload width therebetween. Each connecting rail 920 has a series of anchor points 925 distributed along a longitudinal length. In the depicted embodiment, the anchor points 925 are configured to receive a connecting device vertically oriented. In some embodiments, the anchor points are configured to receive a vertically oriented pin and/or bolt, for examples.

At one of a front end 930 or a back end 935 of the substantially planar surface is an interface bar 940. The interface 940 bar has electrical connectors configured to receive complementary electrical connectors of the payload unit 910 aligned and longitudinally mated thereto. The interface bar 940 presents a vertical locking feature which mates with a complementary vertical locking feature on a received payload unit 910. The vertical locking features, when mated to one another, vertically couple the payload unit 910 to the base unit 905.

The payload unit 910 has a width 945 that is substantially equal to a separation distance between the two connecting rails 920. In practice, the width 945 of the payload unit 910 is a predetermined amount smaller than the distance separating the two parallel connecting rails 920 so as to permit the payload unit 910 to be able to longitudinally slide therebetween. When the payload unit 910 is set upon the substantially parallel surface 915 between the two connecting rails 920, the payload unit 910 may be slidably restricted by the connecting rails 920 to movement substantially only in the longitudinal direction. The payload unit 910 has an electrical connector configured to align with the electrical connector of the interface bar 940. The payload unit 910 has a vertical locking feature (e.g. a projecting member) that is configured to longitudinally align to the complementary vertical locking feature (e.g. aperture sized to receive a projecting member) when the payload unit 910 is upon the substantially planar surface 915 and between the parallel connecting rails 920.

The electrical connector and the vertical locking feature of the payload unit 910 may simultaneously mate with the complementary vertical locking feature and the electrical connector of the interface bar 940, when the payload unit 910 is longitudinally slid into a mating position with respect to the interface bar 940. The payload unit 910 is secured to the base unit 905 by securing a coupling member 950 of the payload unit 910 to a connecting rail 920 of the base unit 905. The coupling member 945 may be securing to the connecting rail 910 by use of a bolt, for example. Note that the coupling member 950 is configured to align to an anchor point 925 when the payload unit 910 is in the mating position with respect to the interface bar 940.

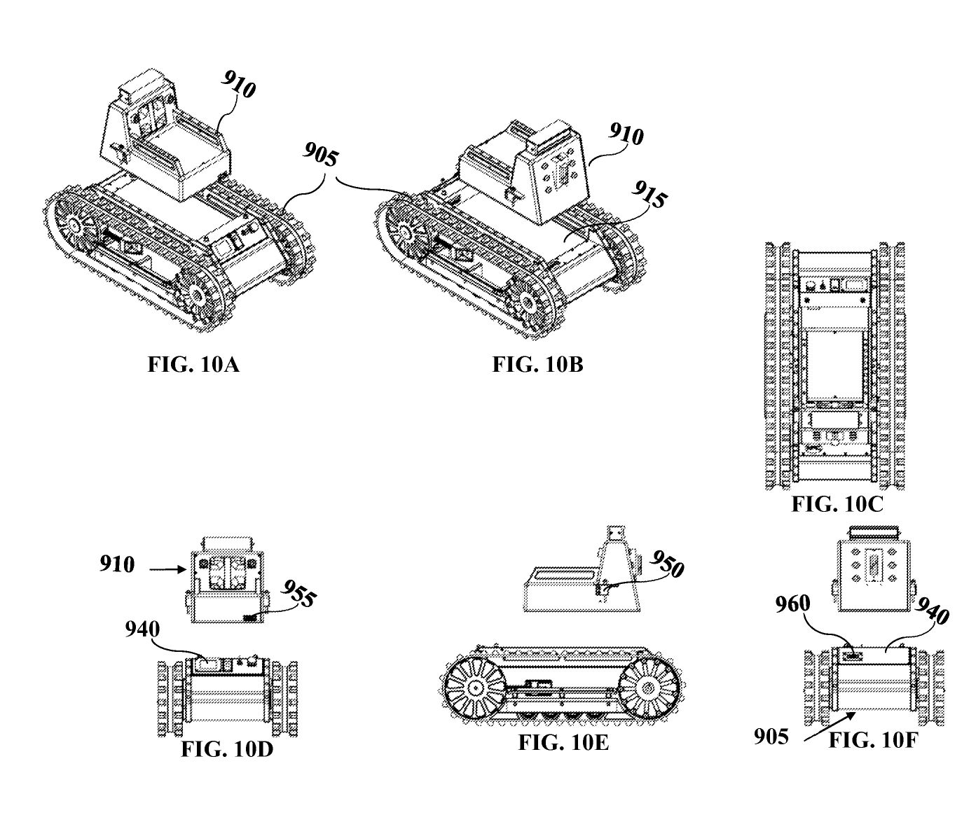

FIGS. 10A-10F depict various views of an exemplary modular robot with an exemplary payload removed. FIGS. 10A-10F depict the exemplary modular configurable robot of FIGS. 9A-9F, but with the payload unit 910 removed from the base unit 905. With the payload unit 910 removed from the base unit 905 some of the above described elements may be better viewed. For example, the substantially planar surface 915 of the mechanical/electrical coupling interface of the base unit 905 can be seen. In some embodiments longitudinal interface rails may be used instead of a substantially planar surface 915. In an exemplary embodiment, longitudinal interface rails may project from laterally inward from the parallel connecting rails, for example.

In the FIGS. 10A-10F depictions, an electrical connector 955 of the payload unit 910 and a complementary electrical connector 960 of the interface bar 940 can be seen. In the depicted embodiment, the vertical locking features of the payload unit 910 and the interface bar 940 have been merged with the electrical connectors 955, 960. Each electrical connector 955, 960 has a mechanical structure that is complementary to that of the other (e.g. plug and socket). The complementary mechanical structure of the electrical connectors are the vertical locking features of this embodiment.

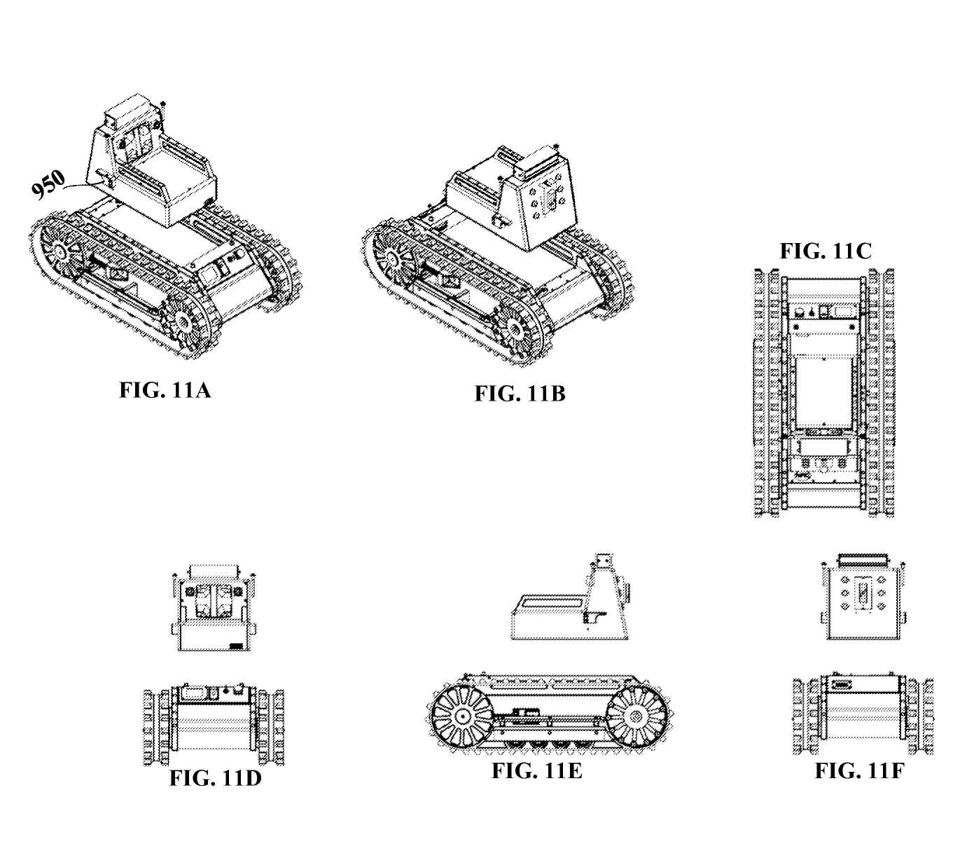

FIGS. 11A-11F depict various views of an exemplary modular robot with an exemplary payload removed and payload connectors removed. FIGS. 11A-11F depict the exemplary modular configurable robot of FIGS. 9A-10F, but with the payload unit 910 removed from the base unit 905 and the securing means removed from the coupling member 950.

FIGS. 12A-12H depict various views of an exemplary modular subsystem assembly for a modular robot. In the FIGS. 12A-12H depictions, an exemplary modular subsystem assembly 1200 is shown. The modular subsystem assembly 1200 includes a hardware cabinet 1205 for receiving the subsystems included in the modular subsystem assembly 1200. The interface bar 940 and parallel connecting rails 920 are mounted upon the modular subsystem assembly 1200. In the depicted embodiment, two module bays 1210, 1215 are accessible from a lateral side of the hardware cabinet 1205. An electronic bay 1210 may be configured to receive a system control module 1215 and motor controllers 1220. A power bay 1215 may be configured to receive a power module 1225. In the depicted embodiment, the power module 1225 may include a battery. The interface bar 940 has a user interface 1230 on an end accessible when the payload unit 910 is in a mating position with respect to the interface bar 940.

In some embodiments, the interface bar 940 may be intended to face backwards and/or toward an operator. In an exemplary embodiment, an LED display may provide user feedback. For example, an LED display may indicate an error code indicative of a subsystem failure, for example. In some embodiments, a back-up camera may be on the interface bar. The interface bar may have a key interlock system to prevent unauthorized robot operations. In an exemplary embodiment, an interface bar may have a battery charge connector. In some embodiments, a transmitting antenna and a separate receiving antenna may be used for operator/robot communications. The robot may have a separate transmitter and receiver, each configured to select a portion of the spectrum for use in RF communications with an operator. Simultaneous transmissions and receptions may be performed using independent transmitters and receivers, for example.

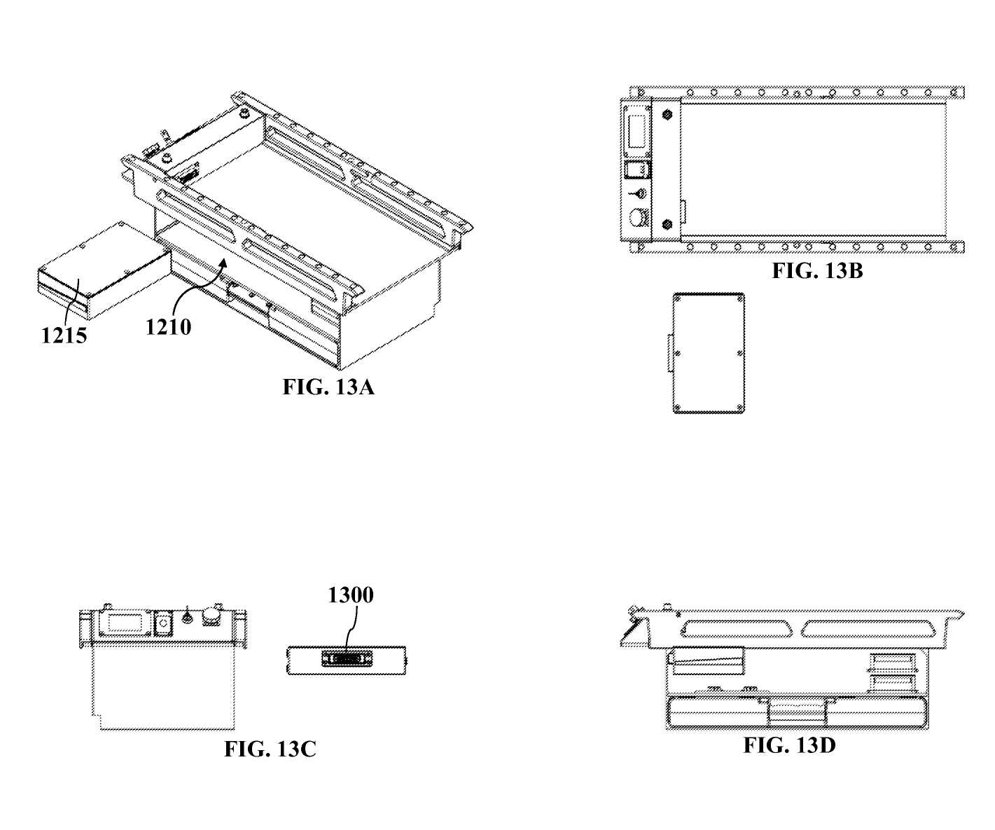

FIGS. 13A-13D depict various views of an exemplary modular subsystem assembly with an exemplary robot control system removed. FIGS. 13A-13D depict the modular subsystem assembly of FIGS. 12A-12H, but with the exemplary system control module 1215 removed from the electronics bay 1210. In the depicted embodiment, the system control module 1215 may be configured to electrically connect to a signal distribution network of the hardware cabinet 1205. An electrical connector 1300 of the system control module 1215 is configured to make electrical connection to the signal distribution network of the hardware cabinet 1205 when the system control module 1215 is in a mating position with respect to the hardware cabinet 1205. The system control module 1215 may be mechanically and electrically coupled to the hardware cabinet simultaneously for example. The system control module 1215 may be configured to be mechanically and electrically connected to the hardware cabinet 1205 without the use of tools, for example.

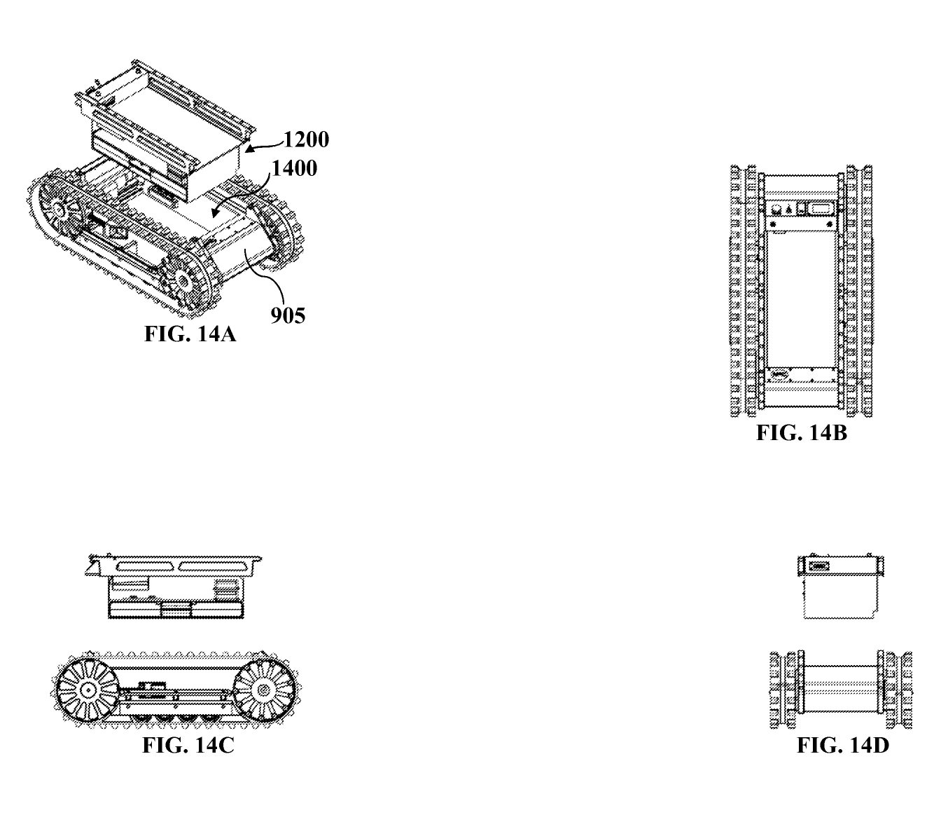

FIGS. 14A-14D depict various views of an exemplary modular robot with a modular subsystem assembly removed. FIGS. 14A-14D depict the exemplary modular configurable robot of FIGS. 9A-11F and the modular subsystem assembly of FIGS. 12A-13D, but with the modular subsystem assembly 1200 removed from the base unit 905. In the depicted embodiment, the modular subsystem assembly 1200 has been vertically removed from a subsystem cavity 1400 of the base unit 905. The modular subsystem assembly 1200 has a lateral inter-cavity geometry that is received into the cavity dimensions such that both lateral and longitudinal play is restricted. Complementary electrical connectors of the base unit 905 and the modular subsystem assembly 1200 are configured to vertically align with one another when the modular subsystem assembly 1200 is inserted into the subsystem cavity 1400 of the base unit. The geometries of one or both of the modular subsystem assembly 1200 and the subsystem cavity 1400 may be keyed such that the modular subsystem assembly 1200 can be inserted into the subsystem cavity 1400 in only one orientation. The modular subsystem assembly 1200 may be secured to the base unit 905 with a connecting device. In some embodiments the connecting device may secure the modular subsystem assembly 1200 to the base unit 905 without the use of tools.

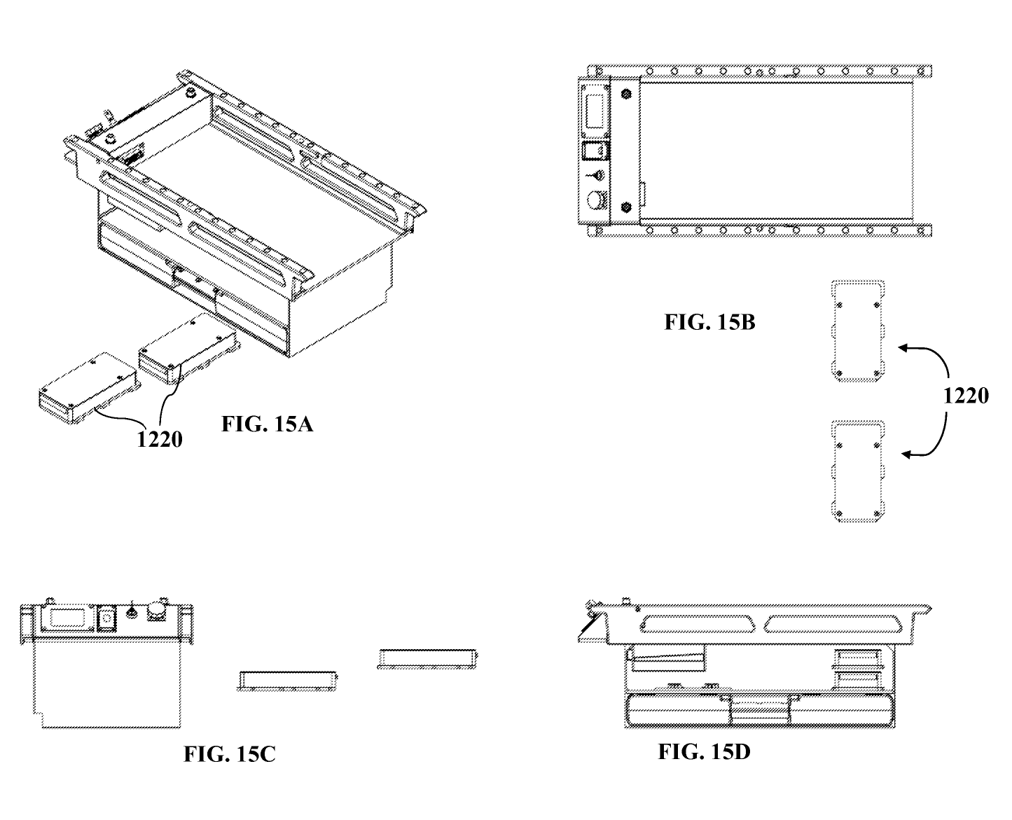

FIGS. 15A-15D depict various views of an exemplary modular subsystems assembly with exemplary motor controllers removed. FIGS. 15A-15D depict the modular subsystem assembly of FIGS. 12A-13D, but with the motor controllers 1220 removed from the electronics bay 1210. In the depicted embodiment, the motor controllers 1220 may be configured to electrically connect to a signal distribution network of the hardware cabinet 1205. An electrical connector of each of the motor controllers 1220 is configured to make electrical connection to the signal distribution network of the hardware cabinet 1205 when the motor controller 1220 is in a mating position with respect to the hardware cabinet 1205. Each motor controller 1220 may be mechanically and electrically coupled to the hardware cabinet simultaneously for example. Each motor controller 1220 may be configured to be mechanically and electrically connected to the hardware cabinet 1205 without the use of tools, for example.

FIGS. 16A-16C depict various views of an exemplary modular robot with a track motor removed. In FIGS. 16A-16C an endless track 1200 has been removed from a base unit 905 so as to permit the removal of a drive motor 1205. To remove the endless track 1200, a user may first decrease tension of the endless track 1200. An idler wheel 1210 may be longitudinally moved via a tensioning system 1215. In the depicted embodiment, the idler wheel 1210 is axially coupled to a mount 1220 that is slidably connected to a frame 1225 of the base unit 905. A screw drive 1230 may be operated to slide the mount 1220 longitudinally along the frame 1225. In some embodiments, the screw drive 1230 may be operated with a tool (e.g. a hex wrench).

After the endless track 1200 has been removed, the drive wheel 1235 can be removed from a drive axel 1240. Then the drive motor 1205 can be removed from the base unit 905. In the depicted embodiment, the drive motor 1205 is secured to the frame 1225 via fasteners connecting a flange 1245 of the drive motor 1205 to the frame 1225. The fasteners may be operated with a tool (e.g. a socket wrench). The fasteners may configured to use the same tool as that needed for the screw drive, for example. The motor can then be slid out of a motor cavity 1250 in the base unit 905. The motor cavity 1250 and the drive motor 1205 are keyed such that the drive motor 1205 can be slid into the motor cavity 1250 in only one axial orientation. The keyed axial orientation may align an electrical connector of the drive motor 1205 to a complementary connector of the base unit 905.

FIGS. 17A-17H depict various views of an exemplary push-to-connect drive motor. In the FIGS. 17A-17H embodiment, the exemplary motor drive 1205 is shown. The motor drive 1205 includes the mounting flange 1245 on a front face 1700. An electrical connector 1705 is on a rear face 1710 of the motor drive 1205. Two sliding keys 1720 longitudinally traverse axially opposite sides of the motor drive 1205. In some embodiments the two sliding keys 1720 have different cross-sectional profiles so as to facilitate the insertion of the motor drive 1205 in only one axial orientation.

FIGS. 18A-18D depict various views of an exemplary modular robot with subsystem assembly and battery removed. FIGS. 18A-18D depict the exemplary modular configurable robot of FIGS. 9A-11F and the modular subsystem assembly of FIGS. 12A-14D, but with the modular subsystem assembly 1200 removed from the base unit 905 and the power module 1225 removed from the modular subsystem assembly 1200. In the depicted embodiment, the power module 1225 has been horizontally removed from the power bay 1215 of the hardware cabinet 1205.

The power module 1225 has a cross-sectional profile that is commensurate to the cavity geometry of the power bay 1215. When the power module 1225 is received into the power bay 1215, vertical and longitudinal movement of the power module 1225 may be substantially restricted. Complementary electrical connectors of the power module 1225 and the modular subsystem assembly 1200 are configured to horizontally align with one another when the power module 1225 is inserted into the power bay 1215 of the hardware cabinet 1205.

FIGS. 19A-19D depict various views of an exemplary subsystem assembly with battery system removed. The FIGS. 19A-19D depictions clearly depict the cross-sectional dimensions of both the power bay 1215. And the power module 1225. In some embodiments, the cross-sectional dimensions may be keyed so as to permit reception of the power module 1225 into the power bay 1215 in only one orientation.

FIG. 20 depicts a schematic diagram of a redundantly controlled robot control system. Exemplary modular configurable robots may have a control system 2000 that is itself adaptable. For example, redundant supervisors 2005, 2010 may oversee the operations of subsystems, many of which have their own processors 2015 and/or controllers 2020. Each subsystem processor 2015 and/or controller 2020 may be in communication with the supervisors 2005, 2010. These supervisors 2005, 2010 may also control the subsystems to optimally perform an intended mission. The supervisor 2005, 2010 may evaluate the health of each of the subsystems to determine optimal resource allocation for mission completion. Redundant supervisors 2005, 2010 may permit one supervisor to fail and still achieve mission success.

The supervisors 2005, 2010 may perform a system capability inventory beginning with a system startup procedure. A supervisor 2005 may sequentially turn on each of the subsystems. To do this, the supervisor 2005 may send a turn-on command signal to a subsystems. The subsystems may then initiate a turn-on sequence in response to the received turn-on command signal. The module then has a hardware heartbeat signal that is communicated to supervisor on a dedicated communications channel (not depicted). If the supervisor does not receive the hardware heartbeat signal, the supervisor may determine that the subsystems is functionally compromised. The supervisor may then reevaluate a resource allocation to determine if the mission can still be completed using the available resources. If the supervisor determines that the mission can still be completed, the supervisor may reschedule the planned operations of the available subsystems.

After each module has been awakened and have reported a hardware heartbeat, the modules periodically will report a software heartbeat on a shared system bus 2025. Each software heartbeat may contain detailed information as to the status of various modules of the subsystem. A motor controller, for example, may report, in a software heartbeat package, the voltage applied and the current drawn by a drive motor. Such a status may indicate to the supervisor that the motor is laboring (e.g. perhaps driving up a grade). Other examples may include a heartbeat reporting a temperature of a component and/or a speed of rotation. Each subsystem may also perform some analyses of the subsystem health based upon these and/or other subsystem metrics. For example, the subsystem may report, in a software heartbeat package, that the subsystem is healthy. Or perhaps the subsystem may report a health grade based upon various subsystem metrics.

Each subsystem may have a set of health codes that are specific to the particular subsystem. The supervisors 2005, 2010 then, after receiving software heartbeats from multiple subsystems, may perform higher level analyses based on the reported metrics. For example, a supervisor 2005, 2010 may receive a power consumption metric of a motor from a motor controller along with an attitude metric from an attitude sensor. The supervisor 2005, 2010 may determine from a high power consumption report combined with an inclined attitude report, that the power consumed by the motors is appropriate for the inclined attitude climb.

Based upon the reported metrics from the various subsystems, the supervisor 2005, 2010 may create one or more system states reflective of one or more combinations of subsystem states. Some of the system states may be associated with predetermined robot conditions. These predetermined robot conditions may have operating procedures associated with them. In some cases, the system state may be a new combination of subsystem metrics. The robot may then associate the measured metrics with this new system state. In this way, the robot may “learn” its own operating capabilities that are achievable in the new state.

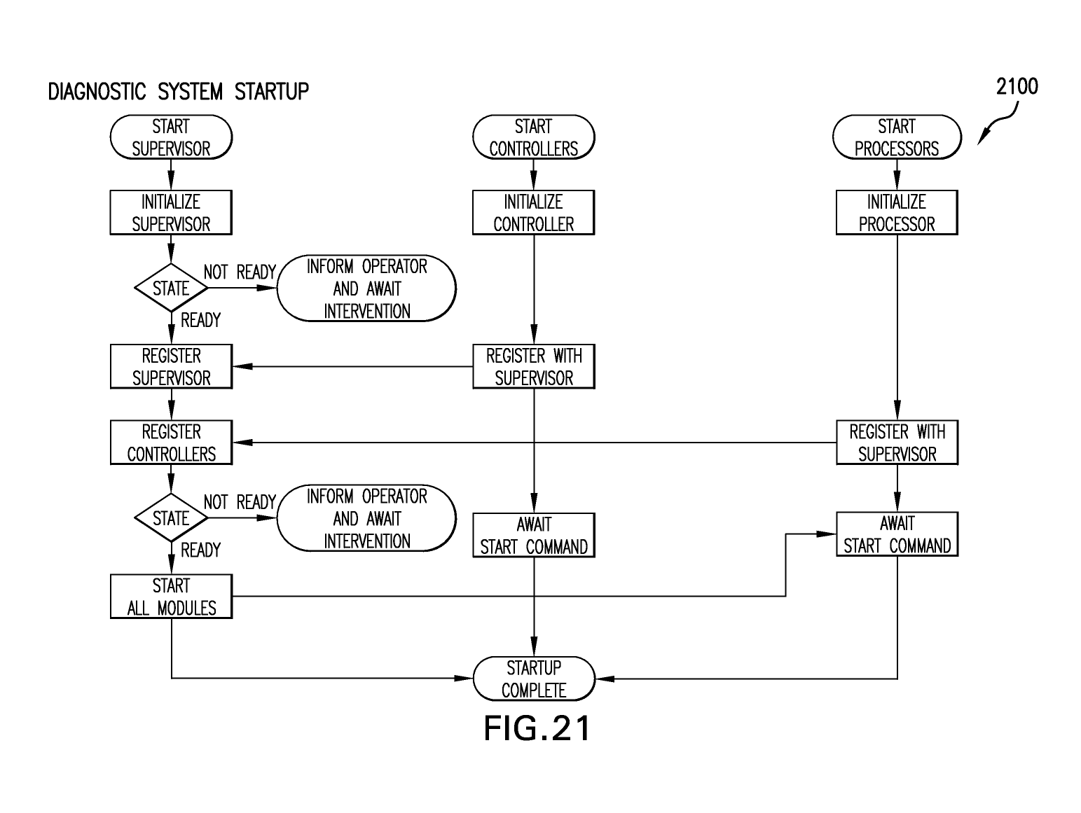

FIG. 21 depicts a flow chart of an exemplary diagnostic system startup method. In FIG. 21, an exemplary startup method 2100 is depicted. The exemplary method begins by initializing the supervisor and/or supervisors. The depicted startup method 2100 then initializes the interface controllers and processors which interface with various robot subsystems. The supervisor then registers all of the initialized controllers and processors in a registry. The supervisor then sequentially sends startup commands to the modules attached to the robots. At various times during the startup diagnostic method 2100 the supervisor informs an operator of the system status.

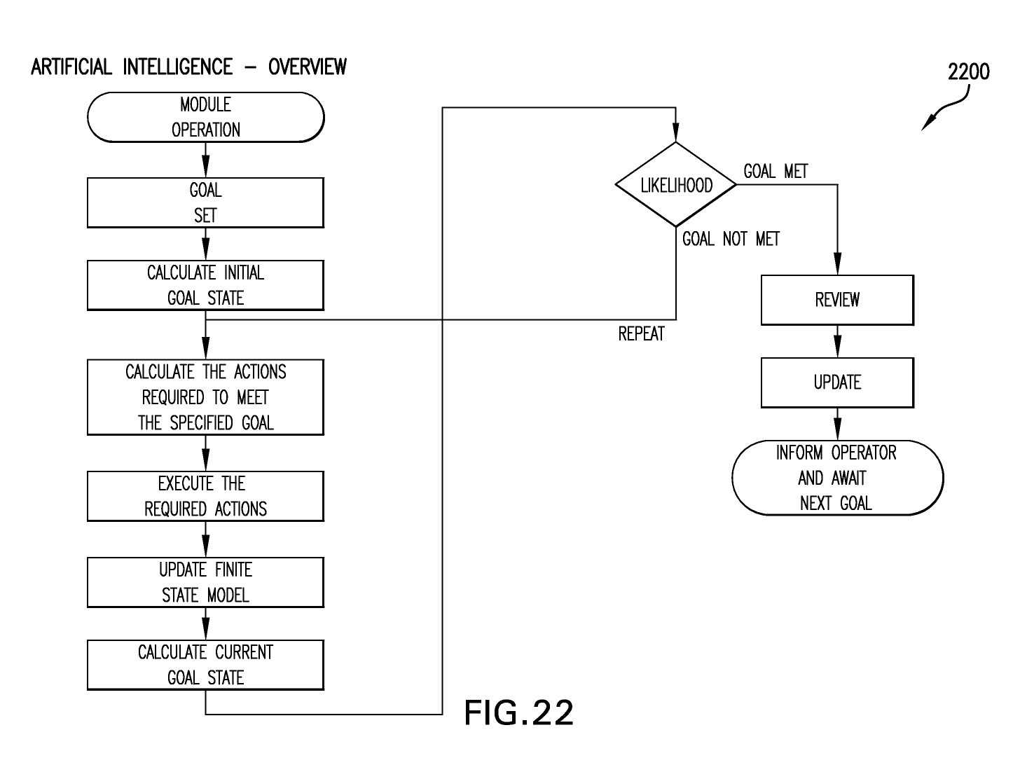

FIG. 22 depicts a flow chart of an exemplary artificial intelligence method. In FIG. 22, an exemplary robot artificial intelligence method 2200 is depicted in flow-chart form. The depicted method discloses an iterative process of achieving an operational goal. The method calculates the actions required to meet the goal and then executes the objectives. The method then calculates the status of the operational goal and determines a measure of success. If the goal is deemed to have not been met, then the process repeats with a new calculation of the actions required to achieve success.

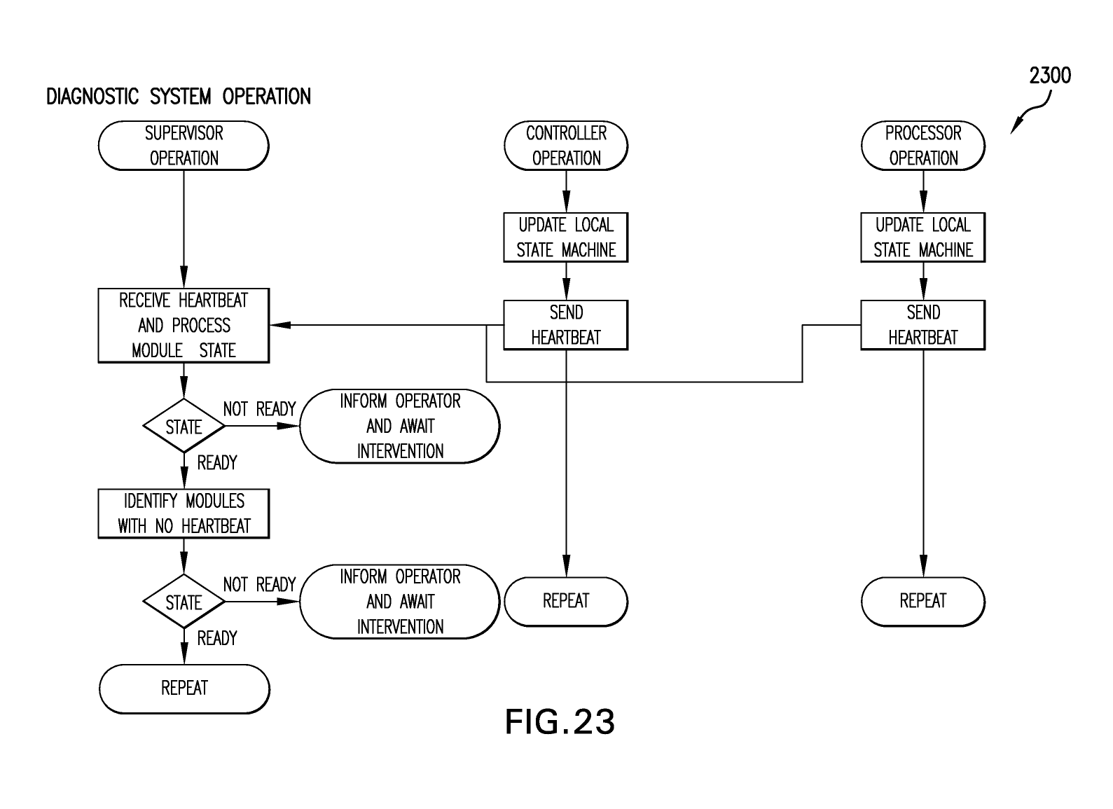

FIG. 23 depicts a flow chart of an exemplary diagnostic system operation method. In FIG. 23, an exemplary diagnostic system operation 2300 is depicted in flow-chart form. In the depicted method, the diagnostic system includes supervisor operations, controller operations, and processor operations.

An exemplary robot may perform a mission that includes a sequence of tasks. Each task may include an ordered set of goals. For each task, the robot may periodically calculate a probability of completing the current set of goals. The goal-achievement probability metric may be calculated using Bayesian statistical methods, for example. The probability of successfully completing the task may be expressed as a confidence measure.

During operation, an exemplary robot may monitor the current state of the robot's various subsystems. For example, the robot may determine an overall health-condition metric for the robot based upon a series of health metrics for the various systems. The overall health-condition metric may, for example, be calculated using a weighted sum of the health metrics of each of the systems, sub-systems, and/or sub-sub-systems. The state of each component may be a numerical representation of the probability that the component accurately will deliver the capability that is designed to deliver. An exemplary robot may calculate the overall health-condition metric using conditional probability mathematics, for example.

In an exemplary scenario, a robot may be tasked to navigate to a destination. The robot may be given a sequence of intermediate waypoints as a path for ultimately reaching the destination. The exemplary navigation process may proceed in the following manner, for example. The robot may first identify whether the current system configuration supports navigation. Then, the robot may determine its current location and calculate a confidence metric associated with the calculated current location. The robot may then compare the calculated confidence metric with a predetermined confidence threshold. If the calculated confidence metric is greater than the predetermined threshold, the robot may calculate a bearing and a distance from the robot's determined current position and a location of the next waypoint.

The robot may then determine if the calculated distance is less than a predetermined threshold, so that the robot can be considered as having achieved that waypoint position. If the robot has not achieved the waypoint position, the robot will then calculate a bearing direction to the waypoint. The robot then may calculate drive speed that will optimally complete the task based on predetermined completion metrics. The robot may then return to the waypoint distance calculation and repeat the subsequent steps until the waypoint position has been achieved.

To determine whether the robot's current system configuration supports navigation, the robot may evaluate whether a requisite set of subsystems is available and operational. For example, an exemplary robot may require a Global Positioning System (GPS) system, a compass, and a motor driver, in order for navigation operations. The GPS system may provide current Universal Transverse Mercator (UTM) coordinates and a current heading, for example. The compass may prove a bearing, and the motor drive may provide locomotion.

In addition to these subsystems, optional subsystems may provide increased navigation abilities. For example, a robot may be equipped with a Light Detection and Ranging (LIDAR) system that provides complex proximity information. Such information may be used in object avoidance tactics during a navigation operation. A robot may be equipped with an ultrasonic array that provides simple proximity information, for example.

A numerical state may be calculated for each of the navigation related subsystems. The numerical state may represent a probability that the subsystem can accurately deliver a capability associated with the subsystem. These numerical states for the various navigation related components may be combined to determine a numerical state for the entire navigation system. The determined numerical state for the entire navigation system may represent a probability that the navigation system can accurately perform a navigation operation.

Prior to each navigation task, the robot may determine this numerical state of the navigation system and compare with a predetermined threshold. And then, only if the numerical state compares favorably with the predetermined threshold will the robot perform the navigation operation, for example. In some embodiments an overall system capability state may be calculated using a weighted sum of numerical states for the requisite individual tasks. In an exemplary embodiment an overall system capability state may be calculated using a product of all the numerical states for the requisite individual tasks.

In some embodiments, a posterior probabilities may be calculated to determine a numerical state of a subsystem. For example, if one assumes a hypothetical scenario that includes the following events: A) the GPS obtains a lock and begins providing location and heading data; and B) the location and heading data of the robot is accurate. If then one assumes that P(A)=0.95, P(B|A)=0.9, and P(B|˜A)=0.1, one can calculate the posterior probability that the GPS has obtained lock given that the robot's bearing and heading data is accurate −P(A|B):

$$P ( A \vert B ) = \frac{P ( A ) P ( B \vert A ) )}{P ( A ) P ( B \vert A ) + P ( ∼ A ) P ( B \vert ∼ A )} .$$

Using the above assumptions, this expressions results in P(A|B)=0.994. Thus the probability that the GPS obtains lock is very high if the robots bearing and location are accurate. Such calculations can be used to evaluate the numerical state of other subsystems as well.

In the same way that the system monitors and updates the probabilities associated with a component, the system also may monitor the effectiveness of the weighting factor for each component and/or may adjust the weighting depending on the outcome of the subsequent task and its associated goals. In this way the system may learn to find the most appropriate weightings for each component capability state, their effect on the system capability state and/or the outcome of the planned task.

For example if the system capability state is marginally less than that required to proceed to the next step the system may arbitrarily adjust probabilities or weightings to achieve the threshold for continuing to the next step. At the completion of the current task the system may then evaluate whether the changes improved the delivery associated goals and the successful completion of the current task. If so the new probabilities or weightings may be stored and re-used the next time the UGV attempts to complete the same type of goal. If not the changes may be discarded.

In some embodiments, a robot may require a precise calculation of a current robot location. The navigation system may use a single sensor to provide location data. The accuracy of the GPS fix may vary over time, and so the quality of a single measurement may be suspect in certain circumstances. These measurement-quality variation may be accounted for using Bayesian Inference, wherein each previous GPS fix is represented within a set of “Prior Classes” or Priors. Using a conjugate prior approach a number of the latest GPS fixes can be used in conjunction with the current fix to increase the systems confidence in its current location. This may be accomplished when the robot is stationary and each GPS fix is not varying due to changes in the position of the UGV.

The prior distribution consisting of historical GPS fixes, associated weighting and/or Likelihood, and the current GPS fix may be evaluated using a Differential Evolution-Markov chain Monte Carlo sampling algorithm to generate a confidence in the current location being within a predetermined location-error distance of the current measured location.

In some embodiments, a robot may calculate bearing and distance of a waypoint form UTM coordinates. As the earth can be represented as a flattened sphere, the distance and bearing between two points depends on the location of the points within the co-ordinate system (e.g. the location on the earth where the two points are). The bearing and distance can be estimated over short distances without taking the co-ordinate system into account. While this may provide adequate navigation parameters in most circumstances, for accuracy an exemplary robot may calculate the distance and bearing between the points using the “Haversine” formula:

$$a = {sin}^{2} ( Δ ϕ ) + cos ( {ϕ}_{1} ) cos ( {ϕ}_{2} ) {sin}^{2} ( \frac{Δ λ}{2} )$$

$$c = 2 atan ( \sqrt{\frac{a}{1 - a}} )$$

$$d = r \cdot c$$

$$bearing = atan ( \frac{sin ( {λ}_{2} - {λ}_{1} ) cos ( {ϕ}_{2} )}{cos ( {ϕ}_{1} ) sin ( {ϕ}_{2} ) - sin ( {ϕ}_{1} ) cos ( {ϕ}_{2} ) cos ( {λ}_{2} - {λ}_{1} )} )$$

In the above calculations, λ is a latitude coordinate and φ is a longitude coordinate.

The modular nature of various exemplary robots may allow new components and capabilities to be added to the robot at any time. If, for example, the navigation task described above uses ultrasonic sensors to provide obstacle vision to facilitate robot navigation around obstacles, a system capability state may be set at an appropriate level. If a LIDAR is added to the system, both a system capability state and a confidence of successfully completing the current task may be increased allowing for successful completion of the navigation task.

Each parameter used to achieve each goal making up a task may be continually monitored and adjusted by a robot numerical state. This may facilitate the robot to “learn” the best parameters for each goal. Numerical state, weighting, and more basic parameters may be adjusted and evaluated once each of the tasks are completed. Over time each individual robot subsystem may store a large number of learned data structures consisting of, for example: 1) the robot configuration; 2) a set of system/component parameters, which may include probabilities and weightings; and 3) a set of task/goal parameters, which may include probabilities and weightings.

Each time two or more UGVs encounter each other, the UGVs will negotiate a quorum and communicate what they have learned between the quorum members. This communication, achieved over IP, RF or Bluetooth 4.0 (BTLe) networks identifies the best parameters for a task or goal and allows each quorum member to try those parameters the next time they complete the described task. Each quorum member then has the option of retaining or discarding the new parameters depending on its experience of task completion.

In some embodiments, numerical states may be determined for each navigation operation. For example, in some embodiments, separate numerical states may be determined for one or more of the following navigation operations: i) identifying a current location; ii) knowing a location of the next waypoint in UTM coordinates; iii) having the ability to calculate the required bearing to the next waypoint; iv) having the ability to calculate the required distance to the next waypoint; v) having the ability to accurately measure the current heading of the robot; vi) having the ability to turn the robot to the required bearing; and vii) having the ability to move the robot towards the next waypoint.

Each of the calculated numerical states may represent a probability that the robot can successfully perform the associated operation. In some embodiments, the robot may embark on the operation if, for example, the minimum calculated numerical state is greater than a predetermined threshold.

FIG. 24 depicts an exemplary waterproof robot emerging from a lake. In the depicted embodiments. The depicted robot 2400 is emerging from a lake 2405. The robot 2400 may have one or more sealed compartments 2410 which may contain modular components. The compartments may be sealed with an adhesive, for example. In some embodiments, a compartment and/or component may be sealed with an O-ring. For example, an axel 2415 of a motor 2420 may have an O-ring 2425 that provides a water-tight seal. The O-ring may be lubricated so as to provide a water-tight seal during dynamic operation of the motor. O-rings may be used to seal access panels of components. Various top-boxes may be attached to a robot to provide mission configuration. These various top-boxes may include various components and/or modules. Each component may be water sealed using a sealing method that is adapted for the component. For example, a camera module may expose a lens that is peripherally sealed to a body. The camera may be fixed focus, for example, which may permit imaging operation without a need for lens movement. In some embodiments, a camera's focal plane array may be moved within the camera body to provide focus, while leaving the lens is a static relationship with the housing. In some embodiments static seals may provide water resistance. In some embodiments dynamic seals may provide water resistance. In some embodiments, the rotational bodies may be water sealed. In an exemplary embodiment a linear moving body may require sealing. In some embodiments various sealants may be used to provide a water tight robot. For example, some interfaces may be sealed using a flat gasket. Some interfaces may be sealed using an adhesive. For example, in an exemplary embodiment a polyurethane glue may be used. In some embodiments an acrylic glue may be used. In an exemplary embodiment, a tolerance glue may be used. Such a glue may provide a uniform separation between two adjacent sealing surfaces. In some embodiments the number of sealing surfaces may be minimized by casting a body as a single piece.

FIG. 25 depicts an exemplary rescue scenario of use for an exemplary modular drone. In the FIG. 25 depiction, a burning house scenario 2500 includes two firefighters 2505, 2510. One firefighter 2505 is applying water to a burning house 2515. The other firefighter 2510 is operating a modular drone 2520 using a remote drone controller 2525. The modular drone 2520 has been driven into the burning house 2515. The modular drone has been outfitted with two distinct payloads 2530, 2535. An infra-red imaging camera payload 2530 is at the fore providing smoke penetrating imagery. A fire extinguishing payload 2535 is shown suppressing the fire nearby a fallen person 2540 in the burning house 2515. The drone operator 2510 may navigate the smoke filled house 2515 and locate a fire victim 2540 within. Heat within the house 2515 may have caused a module of the modular drone 2520 to fail. A self-diagnostic system of the modular drone 2520 may report the failing module 2545 to the drone controller 2525. The self-diagnostic system may calculate the drone's remaining capabilities 2550 absent the failing module. The drone controller 2525 may have a Graphical User Interface (GUI) that presents only operations that are within the wounded drone's capabilities 2550. A GUI may graphically display controls that may operate all drone operations within the wounded drone's capabilities. The GUI may simplify drone operation for an operator 2510 whose brain is otherwise occupied by the crisis situation.

FIG. 26 depicts a block diagram of an exemplary modular drone and exemplary drone controller. In the FIG. 26 embodiment, an exemplary drone controller 2600 is in network communication with an exemplary modular drone 2605. The depicted drone controller 2600 has a transmitter/receiver 2610 which is connected to an antenna 2615. The receiver is configured to receive communications from the depicted drone 2605. The modular drone 2605 also has a transmitter/receiver 2620 which is connected to an antenna 2625. The transmitter/receiver 2620 may be toollessly replaced should the transmitter/receiver 2620 fail. The drone's antenna 2625 may similarly be toollessly replaced should the antenna 2625 fail. The modular drone 2605 may communicate with the controller 2600 using wireless communication, for example. The modular drone 2605 may communicate with a controller 2605 using wired communication, in some embodiments. In an exemplary embodiment, the modular drone may have both wired and wireless communications capabilities. The wireless communications may be performed using Wi-Fi standards, for example. In some embodiments, Bluetooth may be used for communicating between the controller 2600 and the modular drone 2605.

The depicted modular drone 2605 may have various modules deployed. In the depicted embodiment, the modular drone 2605 has two motor drives 2630, 2635. Each of the motor drives 2630, 2635 may be toollessly replaceable. Each of the motor drives 2630, 2635 may be controlled by a motor controller 2640, 2645, for example. Each of the motor controllers 2640, 2645 may be toollessly replaceable, for example. Each motor 2630, 2635 may be independently controlled. In some embodiments, each motor 2630, 2635 may provide locomotive drive to one side of the modular drone 2605, for example. In the depicted embodiment, two top wheels 2650, 2655 may be coupled via a toothed track, for example. The top motor drive 2635 may drive the top wheel 2655, which may in turn drive the top wheel 2650 via the toothed track (not depicted). Similarly, two bottom wheels 2660, 2665 may be coupled together via a toothed track. The bottom motor 2630 may drive the bottom wheel 2660, which may in turn drive the bottom wheel 2665 via the toothed track (not depicted). Each motor drive 2630, 2635 may be identical, which may reduce the number of different replacement parts needed. In an exemplary embodiment, a replaceable drive module may include both a motor drive 2630 and the wheel 2660 driven by the motor drive 2630, for example.

The depicted modular drone 2605 may have a toollessly removable power supply 2670. The power supply may be a battery, for example. Various battery technologies may be used to supply power to the modular drone 2605. In some embodiments, the battery may be a lithium ion battery. In some embodiments, lead-acid batteries may be used. In some embodiments, silver-zinc battery chemistry may be used in the power supply 2670. Nickel-metal hydride batteries may be used in an exemplary embodiment. Nickel-zinc batteries may be used. Other battery technologies may also be employed as power sources, for example according to electrical payload and/or modular drone loading specifications, alone or in combination with, for example, mission duration, environmental exposure, and/or cost, for example.

The modular drone 2605 may have one or more modular payloads 2675 attached. The payload 2675 may be toollessly replaceable. Each payload may be mechanically attached in a toolless manner, for example. Each payload may be electrically attached in a toolless manner. In some embodiments, electrical communication between the payload 2675 and an electronic bay 2680 may be wireless. In some embodiments, electrical communication between the payload 2675 and an electronic bay 2680 may be wired. In some embodiments, the payload 2675 may communicate directly with the controller 2600. A payload 2675 may have its own power source. In some embodiments, the payload 2675 may draw operating power from the modular drone's power supply 2670. The electronics bay 2680 may have toollessly removable components. In some embodiments, a micro-processing component 2685 may be toollessly replaceable, for example. In the depicted embodiment, a payload interface component 2690 may be toollessly replaceable. An image capture component 2695 is also depicted in the FIG. 26 embodiment. In some embodiments, a Global Positioning Module may be included in the electronics bay 2680, for example. In some embodiments, the entire electronics bay may be toollessly replaceable.

In the FIG. 26 embodiment, the drone controller 2600 may have a processor 2602 that may interface with the transmitter/receiver 2610. The processor 2602 may control a man-machine interface. The man-machine interface may include a display screen 2607, for example. On the display screen 2607, the processor 2602 may perform instructions configured to create a Graphical User Interface (GUI). The GUI may use a section of the screen for interfacing with a base portion of the modular drone 2605, for example. In some embodiments, the base portion of the modular drone 2605 may include the drone's mechanical chassis, as well as the wheels 2650, 2655, 2660, 2665 and drive hardware (e.g., tracks). In some embodiments, the power base may include the motor drives 2630, 2635. In various embodiments, the power base may include the power supply 2670. In some embodiments, the power base may include the motor controllers 2640, 2645. In an exemplary embodiment, the power base may include the electronics bay 2680. In an illustrative embodiment, the transceiver/receiver 2620 may be incorporated into the power base. A base GUI 2612 may display operations that control the locomotion of the power base, for example. The base GUI 2612 may report battery status information. The battery status information may include the battery's remaining energy, for example. In some embodiments, the base GUI 2612 may include a graphical depiction of the various components of the power base.

In various embodiments, a self-diagnostic system may monitor the status of various modules. In some embodiments, the self-diagnostic system may be performed by the processor 2685 of the modular drone 2605. In some embodiments, the self-diagnostic system may be performed by the processor 2602 of the drone controller 2600. In some embodiments, each module may perform its own self-diagnostic evaluation. In such an embodiment, each module may report its status to the processor 2685 of the modular drone 2605, for example. In some embodiments, a combination of the above described self-diagnostic methods may be employed. In some embodiments, the processor 2685 may periodically poll a module, requesting status information of the polled module. In some embodiments, the processor 2685 may periodically perform a diagnostic test of a module, for example. In an exemplary embodiment, a module may perform its own self-diagnostic test. In some embodiments, a module may periodically report its status to the processor 2685. The periodic reporting of status may be termed a heart-beat, for example. In some embodiments, the polling of a module may be termed a heart-beat.

The processor 2602 of the drone controller 2600 may perform instructions retrieved from a memory bank 2617. In some embodiments, the memory bank 2617 may have a program region 2627. In some embodiments, the memory bank 2617 may have a data region 2632. The processor may store information received from the drone to a non-volatile storage bank 2622. Various man-machine interface elements may be used to facilitate a user's control of the modular drone 2605. For example, a keyboard 2637 may provide key entry capability between a user and the processor 2602. In some embodiments, a game-type of controller 2642 may receive control instructions from a user and generate electronic signals in response to the control instructions. In some embodiments, the game controller 2642 may have one or more buttons for the user to press. In an exemplary embodiment, the game controller 2642 may have a joystick to receive directional instructions from a user. In an exemplary embodiment, the game controller 2642 may have orientation detectors that convert the controller's orientation into electronic signals. In some embodiments, the controller 2642 may have inertia or motion detectors which convert the game controller movements to electronic signals. In an illustrative embodiment, the game controller 2642 may detect the magnetic field and convert the detected field into an electronic signal.

Various other man-machine interface components may be included in the drone controller 2600. For example, a touch screen display 2647 may permit a user to touch the screen to provide information to the processor 2602. For example, the user may touch a power control to increase the drive power to the modular drone 2605. The user may direct a camera on the drone, for example, by touching a camera elevation grid displayed on the screen. In some embodiments, when a user touches a graphical representation of one of the modules, the processor will send status information for display on the screen.

FIG. 27 depicts an exemplary GUI display of an exemplary drone controller. In the FIG. 27 embodiment, an exemplary GUI display 2700 includes three display regions: a power base region 2705, a first payload region 2710, and a second payload region 2715. The power base region 2705 may include a graphical display of the power level of each of two drive motors, for example. In the depicted embodiment, a left track speed 2720 and a right track speed 2725 are both displayed. In some embodiments, the track speed 2720, 2725 may be changed by touching a location on the speed display region at which a desired speed is annotated, for example. In some embodiments, the battery status 2730 may be graphically displayed in the power base region 2705. A diagnostic display 2735 may graphically indicate a failing module. For example, a flashing symbol of a battery may indicate that the battery is no longer functioning properly. Or a highlighted symbol of a motor controller may indicate a failing motor controller. In some embodiments, the power base region may remove graphical control operators that are incapable of performing their purpose due to a failing module. By removing the graphical interface tool from a user, the available control operations are more simply manifested. In some embodiments, control operations that are rendered inoperable by a failing module may simply be greyed or otherwise indicated inoperable.

The first payload region 2710 in the depicted embodiment shows real-time imagery 2740 as captured by a payload camera. The first payload region 2710 may also display camera angle. In some embodiments, elevation 2745 and azimuth 2750 camera angles may be displayed. In some embodiments camera angles may be graphically depicted and referenced to a silhouette of the modular drone. For example, the camera azimuth 2750 may be shown as a graphical camera turning about the graphical outline of a modular drone. Various payloads may provide various types of information to the payload region 2710 of the display screen 2700. The GUI associated with each payload may be stored in memory in the payload itself, in some examples. This GUI information may be transmitted to a drone controller shortly after power-up of the payload, for example. The GUI information may also be stored in an electronics module associated with the payload. GUI information may also be loaded into the controller in a variety of ways. The controller may download GUI information from the internet, for example. In some embodiments, the GUI information may be preloaded into the controller.

The second payload region 2715 in the depicted embodiment controls a throw-bot launcher. In some scenarios, it may be desirable to infiltrate a facility with a small autonomous mobile robot. In such a scenario, a throw-bot module may be attached to the modular drone. The throw-bot module may be controlled by an associated throw-bot GUI, for example. In the depicted exemplary throw-bot GUI, a launching tube, which projects a throw-bot therefrom may be controlled. The payload may have a range detector and report the range 2755 to the drone controller for display. The payload may have a wind speed detector. The wind speed 2760 may be transmitted to the controller for display. The GUI may use the received range and wind speed to calculate an azimuth angle and an altitude angle for launching the throw-bot. The GUI may calculate, for example, a muzzle velocity 2765 for launch. In some embodiments, a launch button 2770 may be pressed by a user to initiate launch of the throw-bot.

FIGS. 28A-28D depict an exemplary modular power base drone. In FIGS. 28A-28D, an exemplary modular power base 2800 includes left 2805 and right 2810 tracks. The power base 2800 has a payload interface system. The payload interface system includes a mechanical payload interface system and an information payload interface system. The payloads may be coupled to the power base using either the mechanical interface system or the information interface system, or both. In the depicted embodiment, the mechanical interface system includes two substantially parallel rails 2815, 2820 on a top side 2825 of the power base 2800. Each of the rails 2815, 2820 has a plurality of attachment apertures 2830. In the depicted embodiment, the attachment apertures 2830 are regularly spaced along each of the rails 2815, 2820. The attachment rails 2815, 2820 define payload apertures 2835 beneath the attachment rails 2815, 2820. In the depicted embodiment, the payload apertures are of various sizes. These various sized apertures may permit the attachment of various sized payloads, for example. A payload may be mechanically attached to the powerbase using one or more of the attachment apertures 2830, for example. A payload may be mechanically attached to the powerbase using one or more of the payload apertures, for example. In an exemplary embodiment, a payload may attach to the power base using both an attachment aperture and a payload aperture. The attachment of a payload to the power base 2800 may performed toollessly. The top side 2825 of the power base 2800 has two access panels: an electronics bay access panel 2850 and a transceiver access panel 2855. Either access panel 2850, 2855 may be toollessly opened and toollessly closed, in some embodiments.

In the depicted embodiment, an information payload interface system is shown to include an information connection port 2840. The information connection port may include electrical connectors, for example. In some embodiments, the information connection port may include optical connectors. In some embodiments, the information payload interface system may include wireless communication between a payload and the power base 2800. A short range wireless communications system may use Bluetooth protocols for example. Some embodiments may use near field communications standards, for example. In some embodiments can bus communications standards may be used. In an exemplary embodiment, non-standard communications protocols may be used.

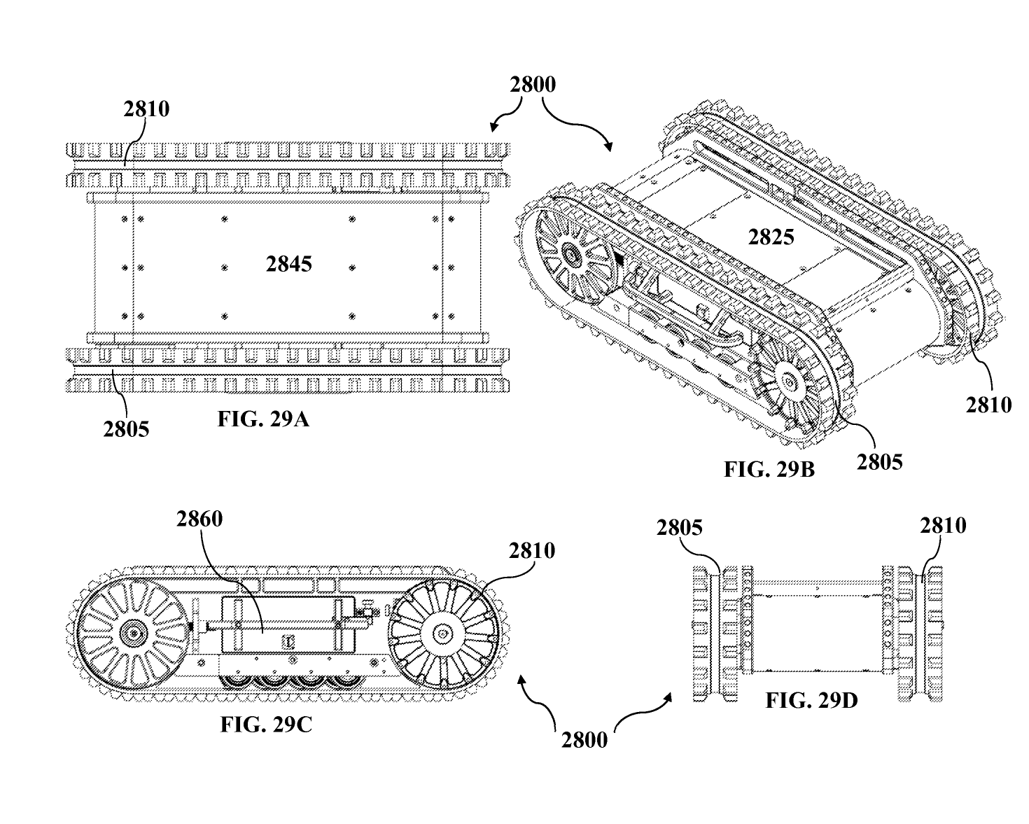

FIGS. 29A-29D depict an exemplary modular power base drone. In the depicted embodiment, a bottom 2845 of the powerbase 2800 is shown. The powerbase 2800 has a side access opening 2860. In some embodiment, the side access opening may be used for toollessly replacing a motor controller. In some embodiments, the side access opening may be used for toollessly replacing a power supply, for example. In some embodiments, the side access panel may be coupled to the power supply.

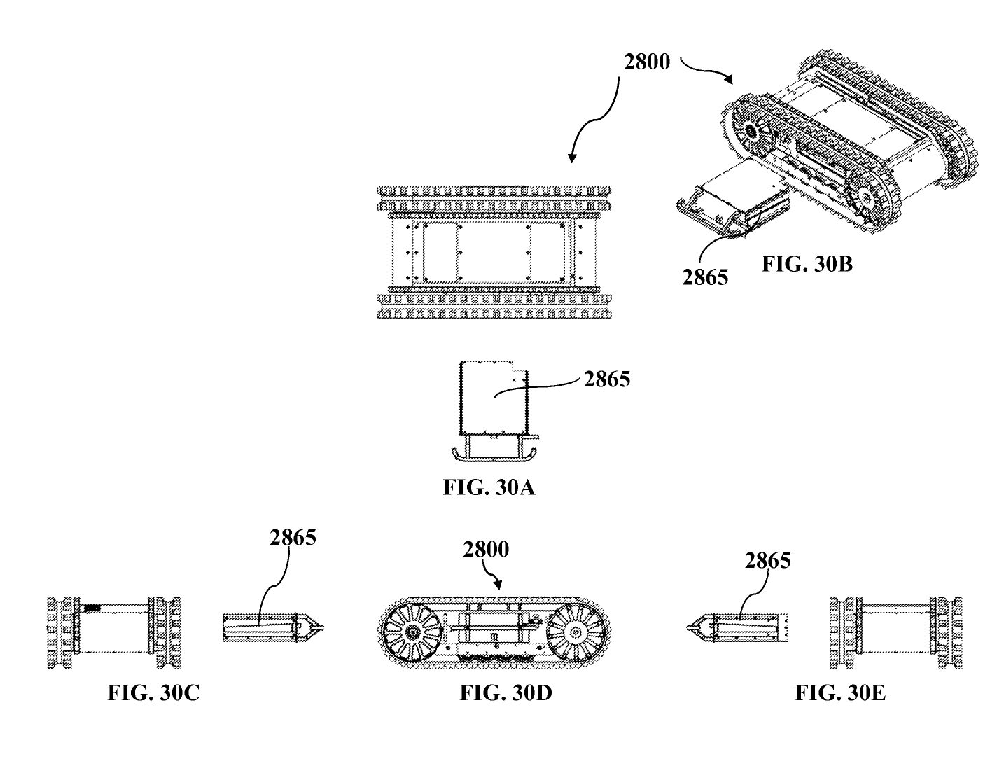

FIGS. 30A-30E depict an exemplary modular power base drone shown with an exemplary removable battery module 2865. In the depicted embodiment, a battery module 2865 is shown after removal from the power base 2800. The battery module 2865 may make electrical connection with a power grid of the power base when the battery module 2865 is fully inserted into the power base 2800. In some embodiments, a power connector on the battery module 2865 may be aligned with a power connectors attached to the power base 2800, so that when inserted the two power connectors properly mate with each other. In some embodiments, a toolless latching mechanism may be used to securely attach the battery module 2865 to the power base 2800.

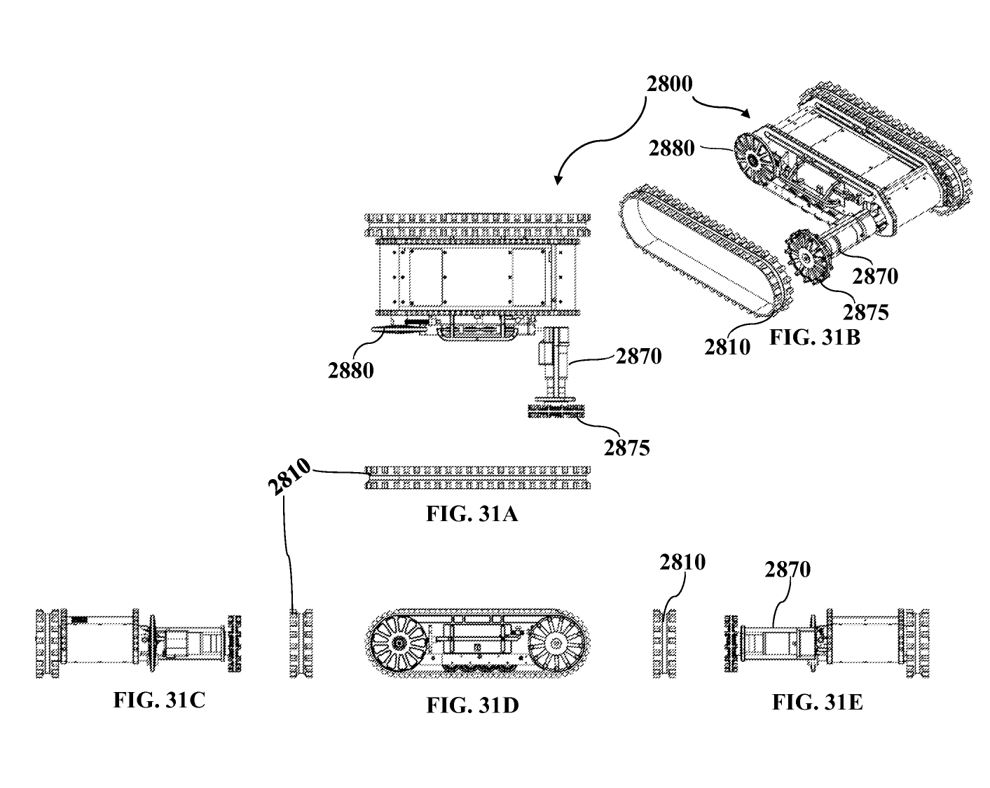

FIGS. 31A-31E depict an exemplary modular power base drone shown with an exemplary replaceable drive motor module. In the depicted embodiment, a drive motor 2870 is show removed from the power base 2800. The right track 2810 has been removed as well. The exemplary drive motor 2870 includes a drive wheel 2875. In some embodiments, a power connector on the motor drive 2870 may be aligned with a power connector attached to the power base 2800, so that when inserted the two power connectors properly mate with each other. In some embodiments, a toolless latching mechanism may be used to securely attach the drive motor 2870 to the power base 2800. In some embodiments, a toolless adjustment mechanism provides a means for adjusting the separation distance between the drive wheel 2875 and a second wheel 2880. When removing a drive motor 2870, for example, the separation distance between the two wheels 2875, 2880 may be decreased so as to loosen the track 2810. The track 2810 may then be removed. After removal of the track, the motor drive 2870 may be removed, for example.

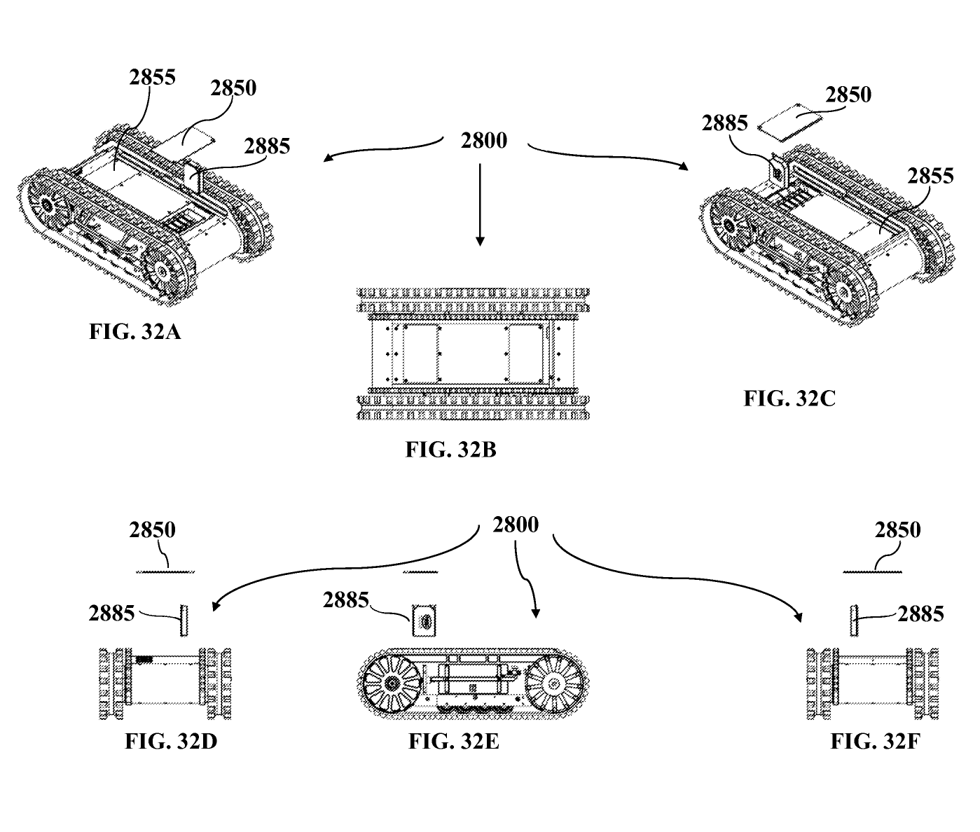

FIGS. 32A-32F depict an exemplary modular power base drone shown with an exemplary accessible system control module. In the depicted embodiment, the electronics bay access panel 2850 is shown both removed and attached to the power base 2800. The electronics bay access panel has been removed in FIGS. 32A and 32C-32F. In these FIGS. 32A and 32C, the electronics modules can be seen in an electronics bay. One of the electronics modules 2885 is shown removed in these figures. In some embodiments, the electronics modules may be toollessly replaced from the electronics bay. In some embodiments the electronics bay access panel 2850 may be toollessly removed and toollessly attached to the power base 2800.

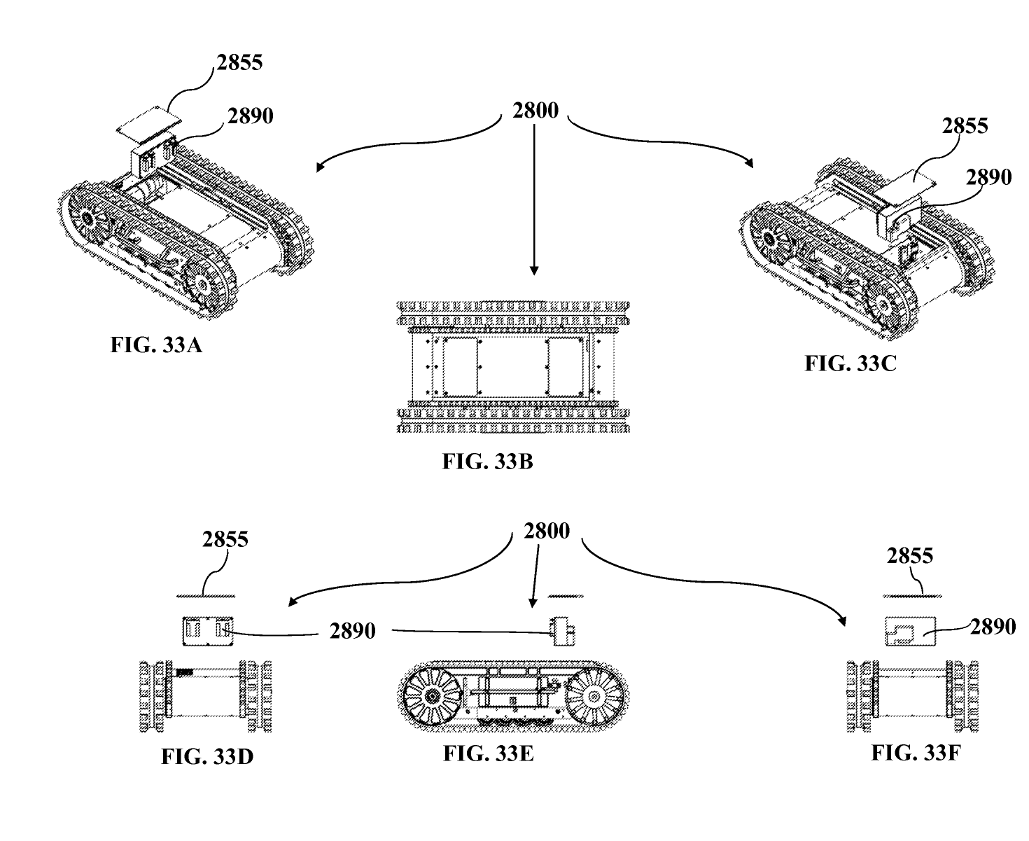

FIGS. 33A-33F depict an exemplary modular power base drone shown with an exemplary replaceable transmitter/receiver module. In the depicted embodiment, the transceiver bay access panel 2855 is shown both removed and attached to the power base 2800. The transceiver bay access panel has been removed in FIGS. 33A and 33C-33F. In these FIGS. 33A and 33C, the transceiver module 2890 can be seen in the transceiver bay. The transceiver module 2890 is shown removed in these figures. In some embodiments, the transceiver module may be toollessly replaced from the transceiver bay. In some embodiments the transceiver bay access panel 2855 may be toollessly removed and toollessly attached to the power base 2800.

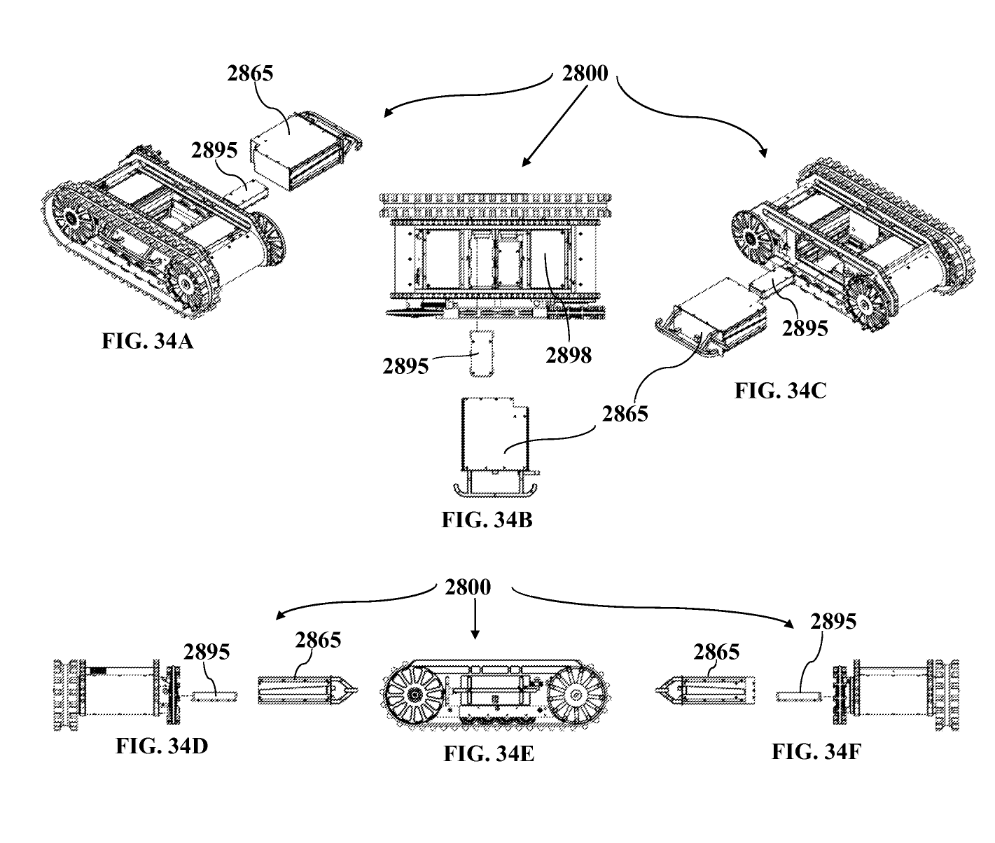

FIGS. 34A-34F depict an exemplary modular power base drone shown with an exemplary replaceable motor controller module. In the depicted embodiment, an exemplary motor controller 2895 is shown both removed and attached to the power base 2800. The battery module 2865 has been removed. The removal of the battery module 2865, in this embodiment, permits access to two motor control modules 2895, 2898. In some embodiments, the motor controllers 2895, 2898 may be toollessly replaced via an access panel. In some embodiments, an electrical connector on the motor controller 2895 may be aligned with a mechanical coupling mechanism so that upon mechanical insertion, the electrical connector provides electrical connections between the motor controller 2895 and the power base 2800.

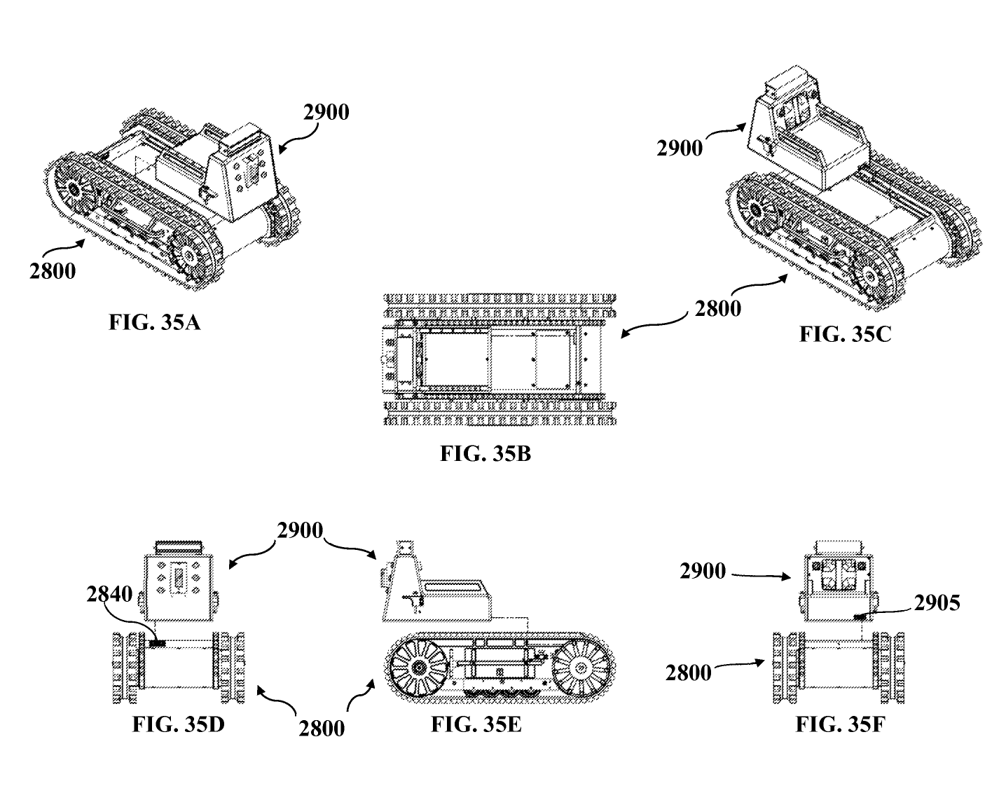

FIGS. 35A-35F depict an exemplary modular power base drone shown with an exemplary attachable surveillance payload module. In the depicted embodiment, an exemplary payload 2900 is shown both connected and detached from a power base 2800. In FIGS. 35A and 35C-35F the exemplary payload is detached from the power base 2800. An information connection port 2905 on the payload 2900 may make connection to the payload information connection port 2840 on the power base 2800. In various embodiments, the payload 2900 may be toollessly connected to the power base 2800. In some embodiments, an electronic module may be associated with a specific payload. In some embodiments, no electronic module need be associated with a specific payload. The depicted payload may be a surveillance module, for example. The surveillance module may provide real time video capture to the power base 2800, which may then transmit the video to a remotely located drone controller.

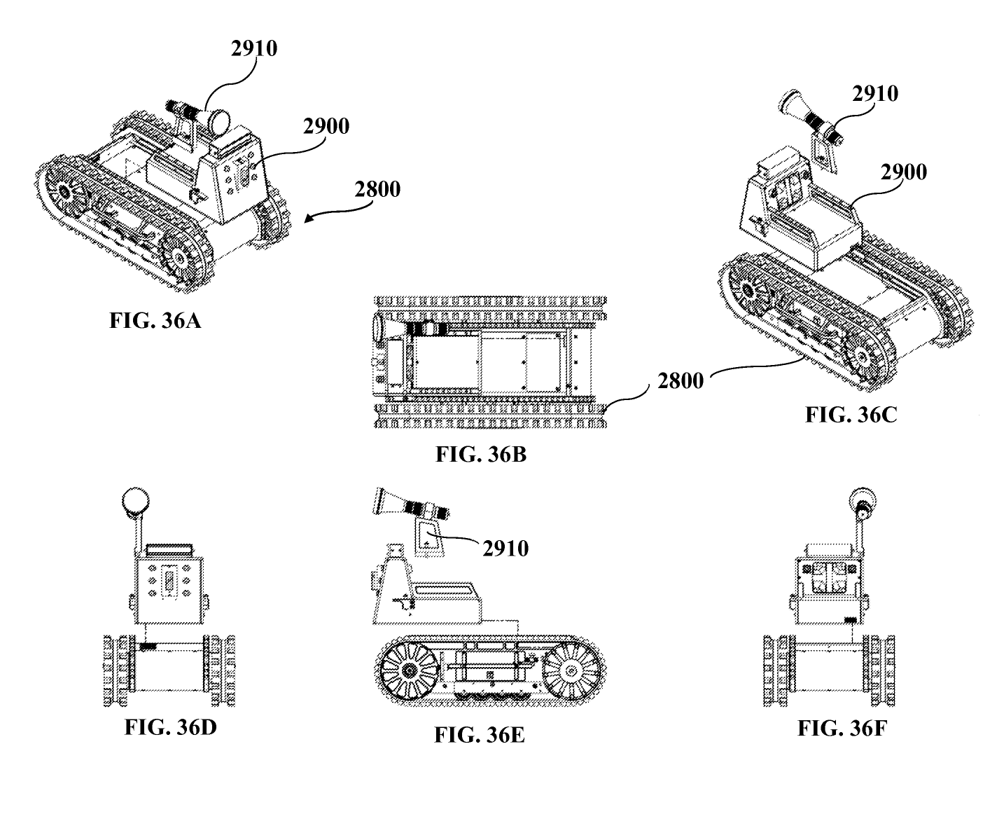

FIGS. 36A-36F depict an exemplary modular power base drone shown with an exemplary attachable surveillance payload module and exemplary attachable net gun module. In the depicted embodiment, two payloads 2900, 2910 are shown both attached and detached from the power base 2800. A net gun module 2910 may be coupled to the surveillance module, for example. In the depicted embodiment, the surveillance module 2900 may exchange information with the net gun module 2910. In some embodiments, the surveillance module 2900 may simply buffer the payload information connection system and provide it to the net gun module 2910 for information exchanges between the net gun module 2910 and the power base 2800.

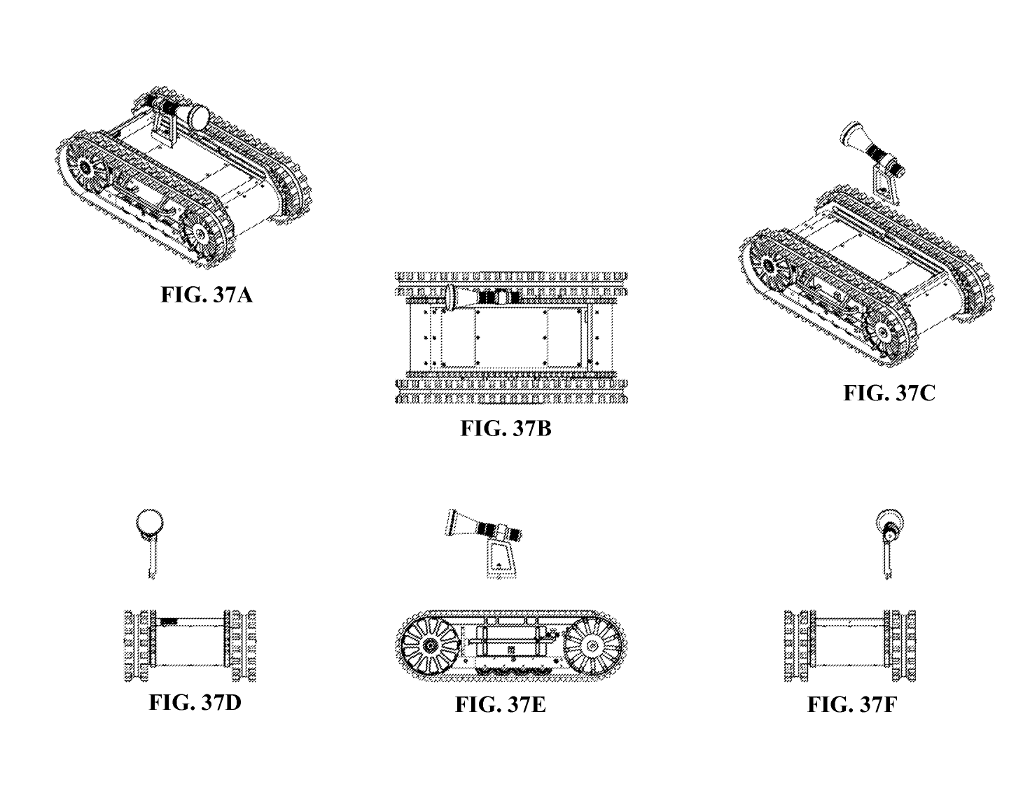

FIGS. 37A-37F depict an exemplary modular power base drone shown with an exemplary attachable net gun module. In the depicted embodiment, a net gun module 2910 is shown both connect to and detached from a power base 2800. In some embodiments, a robot's base may be configured quickly and easily with a variety of tactivcal deployment modules. Modular design and self-diagnostics may enable replacement of all critical components in the field. Because of the modularity of some exemplary robots, the power base may be situationally adapted to provide mission specific capabilities.

Although various embodiments have been described with reference to the Figures, other embodiments are possible. For example, various embodiments may provide various methods of locomotion. In some embodiments, locomotion may be performed using wheels. In some embodiments, four wheels may be used. In an exemplary embodiment, eight wheels may contact the ground and provide locomotion. In some embodiments, two wheels may provide drive to the modular drone. In some embodiments, four drive wheels may provide motion to a drone. In some embodiments, a single drive motor may drive two wheels. In an exemplary embodiment, motion may be supplied by moving legs. In some embodiments, a drone may be moved using hovercraft technology. In an illustrative example, the type of locomotion may be changed by exchanging the modular drive mechanism with a new drive mechanism. This exchange of drive mechanism may be toollessly performed in some embodiments.

In an illustrative embodiment, the self-diagnostics may be performed at multiple levels. For example, in some embodiments, each module may perform periodic self-diagnosis. A power base, may periodically diagnose each module independently, for example. In some examples, both diagnoses may be transmitted to a remote drone controller. A drone controller may use the self-diagnostic information to provide a user with a recommended strategy. For example, if one of the motors is inoperable, the recommendation may be to suggest the user actuate a linking member between both sides of the drone locomotion assembly. When the two sides are linked, for example, the drone may be capable of forward and reverse travel. If turning is desired, unlinking may provide a turning mechanism for a drone having one drive side capability.

In some embodiments, a GPS system may provide the return path to the drone. In an exemplary embodiment, the time sequence of the motor actuation that was used during deployment may be used to recreate a return path motor activation sequence. In some embodiments, a user may send a return to home command, to which the drone may respond by backwards tracing the route taken to the deployed location, for example.

Drones may be used as a surrogate for a person in dangerous situations. For example, flying drones may be used by the military to perform reconnaissance operations in enemy territories. Specialized drones may be equipped with specialized equipment to perform mission unique functions. Some military drones may collect battlefield imagery. Some military drones may be equipped with weapons. Flying drones may come in different sizes for performing different mission operations. Some large drones may have long range capabilities, while small drones may be employed for local operations, for example.

Drones also may be used in non-military applications. For example, drones may be used to explore caves within the earth. Drones may be used to assist law enforcement personnel, for example. Drones or robots also may be used recreationally as battling entities. Various organizations may establish battling rules for different classes of robots. People then may program and enter their robots into the battling tournament.

Some aspects of embodiments may be implemented as a computer system. For example, various implementations may include digital and/or analog circuitry, computer hardware, other sensors (e.g. temperature sensors), firmware, software, or combinations thereof. Apparatus elements can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Some embodiments can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example and not limitation, both general and special purpose microprocessors, which may include a single processor or one of multiple processors of any kind of computer. Generally, a processor will receive instructions and data from a read-only memory or a random access memory or both. The essential elements of a computer are a processor for executing instructions and one or more memories for storing instructions and data. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and, CD-ROM and DVD-ROM disks. The processor and the memory can be supplemented by, or incorporated in, ASICs (application-specific integrated circuits). In some embodiments, the processor and the member can be supplemented by, or incorporated in hardware programmable devices, such as FPGAs, for example.

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. An exemplary embodiment may be implemented in a computer system that includes a graphical user interface and/or an Internet browser. To provide for interaction with a user, some implementations may be implemented on a computer having a display device, such as an LCD (liquid crystal display) monitor for displaying information to the user, a keyboard, and a pointing device, such as a mouse or a trackball by which the user can provide input to the computer. For example, wearable devices, such as Google Glasses or other technologies may facilitate input and/or output operations between a user and a system.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, and the computers and networks forming the Internet. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, Firewire, ATA/IDE, RS-232, RS-422, RS-485, 802.11 a/b/g/n, Wi-Fi, Ethernet, IrDA, FDDI (fiber distributed data interface), token-ring networks, or multiplexing techniques based on frequency, time, or code division. Some implementations may optionally incorporate features such as error checking and correction (ECC) for data integrity, or security measures, such as encryption (e.g., WEP) and password protection.

A number of implementations have been described. Nevertheless, it will be understood that various modification may be made. For example, advantageous results may be achieved if the steps of the disclosed techniques were performed in a different sequence, or if components of the disclosed systems were combined in a different manner, or if the components were supplemented with other components. Accordingly, other implementations are contemplated.

1. An endless-track drive wheel comprising:
a wheel disc having a central axis, opposite first and second faces, and a continuously-cylindrical rolling surface, wherein the rolling surface is everywhere less than a radial distance, r₁, from the central axis;
a first plurality of cogs axially projecting from the first face of the wheel disc and disposed periodically along a substantially circular path at a radial distance, r₂, from the central axis of the wheel disc, wherein each of the first plurality of cogs has a cylindrical rolling surface that is rotatable about an axis of the cog, wherein the axis of each of the first plurality of cogs is aligned substantially parallel with the central axis of the wheel disc, wherein the rotatable surface has a radial distance, r₃, from the axis of the cog;
wherein the sum of the radial distances, r₂ and r₃, is greater than the radial distance, r₁.

2. The endless-track drive wheel of claim 1, further comprising a second plurality of cogs axially projecting from the second face of the wheel disc and disposed periodically along a continuously circular path at a radial distance, r₂, from the central axis of the wheel disc, wherein each of the second plurality of cogs has a cylindrical rolling surface that is rotatable about an axis of the cog, wherein the axis of each of the first plurality of cogs is aligned parallel with the central axis of the wheel disc, wherein the rotatable surface has a radial distance, r₃, from the axis of the cog.

3. The endless-track drive wheel of claim 2, wherein each of the second plurality of cogs is axially aligned with one of the first plurality of cogs.

4. The endless-track drive wheel of claim 1, wherein each of the first plurality of cogs comprises a rigid axis and a roller bushing.

5. The endless-track drive wheel of claim 1, wherein each of the first plurality of cogs comprises a rigid axis and a roller bearing.

6. An endless-track drive system comprising:
an endless track belt loop having an inside surface and an outside surface defining a loop length and a belt width, the inside surface having a first plurality of raised lugs and a second plurality of raised lugs periodically disposed along the loop length on opposite sides of a center wheel path;
a drive wheel including:
a wheel disc having a central axis, opposite first and second faces, and a continuously-cylindrical rolling surface, wherein the rolling surface is everywhere less than a radial distance, r₁, from the central axis;
a first plurality of cogs axially projecting from the first face of the wheel disc and disposed periodically along a substantially circular path at a radial distance, r₂, from the central axis of the wheel disc, wherein each of the first plurality of cogs has a cylindrical rolling surface that is rotatable about an axis of the cog, wherein the axis of each of the first plurality of cogs is aligned parallel with the central axis of the wheel disc, wherein the rotatable surface has a radial distance, r₃, from the axis of the cog,
wherein the sum of the radial distances, r₂ and r₃, is greater than the radial distance, r₁,
wherein a separation distance between adjacent pairs of the first plurality of cogs is greater than a separation distance between adjacent pairs of the first plurality of raised lugs.

7. The endless-track drive system of claim 6, further comprising a second plurality of cogs axially projecting from the second face of the wheel disc and disposed periodically along a continuously circular path at a radial distance, r₂, from the central axis of the wheel disc, wherein each of the second plurality of cogs has a cylindrical rolling surface that is rotatable about an axis of the cog, wherein the axis of each of the first plurality of cogs is aligned parallel with the central axis of the wheel disc, wherein the rotatable surface has a radial distance, r₃, from the axis of the cog.

8. The endless-track drive system of claim 7, wherein each of the second plurality of cogs is axially aligned with one of the first plurality of cogs.

9. The endless-track drive system of claim 7, wherein a separation distance between adjacent pairs of the second plurality of cogs is greater than a separation distance between adjacent pairs of the second plurality of raised lugs.

10. The endless-track drive system of claim 6, wherein each of the first plurality of cogs comprises a rigid axis and a roller bushing.

11. The endless-track drive system of claim 6, wherein each of the first plurality of cogs comprises a rigid axis and a roller bearing.

12. The endless-track drive system of claim 6, wherein the endless track belt loop is configured to engage and circumscribe the drive wheel.

13. The endless-track drive system of claim 6, wherein, when the endless track belt loop engages and circumscribes the drive wheel, wherein only one of the first plurality of cogs engages with any of the first plurality of lugs.

14. The endless-track drive system of claim 6, wherein the endless track belt loop engages and circumscribes the drive wheel, wherein the rolling surface of the wheel disc does not contact the center wheel path of the endless-track belt loop.

15. The endless-track drive system of claim 6, further comprising a robot.

16. An endless-track drive system comprising:
an endless track belt loop having an inside surface and an outside surface defining a loop length and a belt width, the inside surface having a first plurality of raised lugs and a second plurality of raised lugs periodically disposed along the length on opposite sides of a center wheel path;
a drive wheel; and
means for engaging the drive wheel and the endless track in a slip-drive fashion.

17. The endless-track drive system of claim 16, wherein engaging means comprises a plurality of roller bushings periodically disposed along a periphery of the drive wheel.

18. The endless-track drive system of claim 17, wherein the drive wheel has n-fold rotational symmetry, where n is an integer greater than or equal to three.

19. The endless-track drive system of claim 16, wherein the drive wheel has n-fold rotational symmetry, where n is an integer greater than or equal to six.

20. The endless-track drive system of claim 16, wherein the drive wheel has n-fold rotational symmetry, where n is an integer greater than or equal to eight.
